(19) United States
(12) Patent Application Publication
(10) Pub. No.: US 2023/0118566 A1
(43) Pub. Date: Apr. 20, 2023

(54) ELASTIC MATERIALS PREPARED FROM CURABLE LIQUID COMPOSITIONS

(71) Applicant: Arkema France, Colombes (FR)

(72) Inventors: Zahidul Amin, Kanagawa (JP); Toshiya Sugimoto, Kanagawn (JP); Mingxin FAN, Guangzhou (CN)

(21) Appl. No.: 17/915,165

(22) PCT Filed: Apr. 1, 2021
(86) PCT No.: PCT/EP2021/058549

§ 371 Date: Sep. 28, 2022

(30) Foreign Application Priority Data
Apr. 1, 2020 (FR) FR2003252

(51) Int. Cl. C08F 220/34; C08F 2/48; C08F 283/00; C08G 18/48

(52) U.S. Cl. CPC C08F 220/343; C08F 2/48; C08F 283/008; C08G 18/4854

(57) ABSTRACT

The invention relates to an elastic material having high rebound resilience, which is an energy-cured material obtained from a composition comprising a specific urethane (meth)acrylate comprising oxybutylene units.

### FIELD OF THE INVENTION

The present invention relates to an elastic material having high rebound resilience, which is an energy-cured material obtained from a composition comprising a specific urethane (meth)acrylate comprising oxybutylene units.

### BACKGROUND OF THE RELATED ART

Energy-curing (EC) refers to the conversion of a curable composition (which may also be referred to as a “resin”) to a polymer using an energy source such as an electron beam (EB), a light source (for example a visible light source, a near-UV light source, an ultraviolet lamp (UV) a light-emitting diode (LED), or an infrared light source) and/or heat. A composition that is capable of being polymerized through exposure to such an energy source may be referred to as an energy-curable composition. A material that is prepared by polymerizing a curable composition with EB, a light source (for example visible, near-UV, UV LED or infrared) and/or heat can be regarded as an energy-cured material.

A wide range of material properties is potentially accessible with energy curing technology. This breadth is evident by the many applications that use energy-curable compositions: wood coatings, plastic coatings, glass coatings, metal coatings, finish films, mechanical performance coatings, durable hardcoats, inkjet inks, flexographic inks, screen inks, over-print varnishes, nail gel resins, dental materials, pressure-sensitive adhesives, laminating adhesives, electronic display components, photoresists, 3D-printing resins, and more. However, the industry is continually working to access new “material property space” that has previously been out of reach for energy-curable compositions and materials prepared therefrom. Property space refers to combinations of different material properties given certain constraints. For certain end uses, energy-cured materials having elastic properties would be of great interest. However, energy-curable compositions which are capable of being energy-cured to yield elastic materials have to date not been widely explored or developed.

In order to achieve the rebound resilience desired in an elastomer, a material must 1) deform under stress and 2) quickly return to its original shape after the stress is removed. In a polymeric material, crosslinking between the polymer chains decreases its ability to deform. Thus, too much crosslinking will preclude any rebound resilience. On the other hand, crosslinking may be required for the material to return to its original shape after the stress is removed. For a given composition, there is a crosslink density that provides optimal rebound resilience. A material's elongation is also highly dependent on the crosslink density; crosslinking decreases elongation. The crosslink density required for rebound is enough to severely limit the elongation. For this reason, the defining challenge in formulating an energy-curable composition that is capable of providing an elastic material once cured is simultaneously obtaining high elongation and high rebound resilience.

### SUMMARY OF THE INVENTION

One aspect of the present invention is an elastic material having a rebound resilience greater than 10%, in particular greater than 15%, more particularly greater than 20% as measured according to JIS K 6255:1996. The elastic material is an energy-cured reaction product of a curable composition comprising components a) and b):
Component a): 30 to 90%, in particular 40 to 90%, more particularly 50 to 90% by weight, based on the total weight of components a) and b) of at least one urethane (meth)acrylate having a number average molecular weight of at least 4,700 g/mol and comprising oxybutylene units;
Component b): 10 to 70%, in particular 10 to 60%, more particularly 10 to 50% by weight, based on the total weight of components a) and b), of at least one (meth)acrylate monomer having one or two (meth)acrylate functional groups per molecule.

As will be explained in more detail subsequently, the curable composition may optionally contain one or more further components, in particular an initiator system such as one or more photoinitiators.

The invention also relates to a method of making the elastic material according to the invention by curing the curable composition as defined herein.

### DETAILED DESCRIPTION OF EMBODIMENTS OF THE INVENTION

Definitions

In the present application, the term “comprise(s) a/an” means “comprise(s) one or more”. Unless mentioned otherwise, the % by weight in a compound or a composition are expressed based on the weight of the compound, respectively of the composition.

The term “X is substantially free of Y” means that X comprises less 10%, less than 5%, less than 2%, less than 1%, less than 0.5%, less than 0.1%, less than 0.01%, or even 0% by weight of Y.

The term “Cα-Cβ group” wherein α and β are integers means a group having a number of carbon atoms from α to β.

The term “elastic material” refers to a material having one or more elastomeric properties such as, qualitatively, high elongation, high rebound resilience, high elasticity, and/or high elastic recovery. Further, the elastic material may have adequate toughness. Quantitatively, these properties will vary depending on the specifics of the end use application for the elastic material. Elongation refers to the total deformation of a sample before breaking. High elongation might be more than 200%, more than 300%, more than 400% or more than 500% as measured according to the method defined herein. Rebound resilience refers to the rebound height of an object that bounces off the surface of the material, expressed as a percent of the object's original height. High rebound resilience might be more than 10%, more than 15%, more than 20%, more than 30% or more than 40% as measured according to the method defined herein. Toughness refers to the integration of a tensile stress-strain curve and elasticity refers to the maximum deformation to which a material can be stretched and still return to its original shape. High elasticity might be more than 100%, more than 200% or more than 300% when tested according to ASTM D882-18. In addition, fast rebound speed is also desired. These material properties are not unrelated. For example, all else being equal, higher elongation generally means lower toughness, while good elastic recovery is associated with good rebound resilience.

The term “(meth)acrylate functional group” refers to either an acrylate functional group (—O—C(═O)—CH═CH₂) or a methacrylate functional group (—O—C(═O)—C(CH₃)═CH₂). When not followed by the phrase “functional group,” the term “(meth)acrylate” refers to a chemical compound that contains at least one acrylate functional group per molecule or at least one methacrylate functional group per molecule. “(Meth)acrylate” can also refer to a chemical compound that has both at least one acrylate functional group and at least one methacrylate functional group. “Functionality” refers to the number of (meth)acrylate functional groups per molecule. It does not refer to any other functional groups besides (meth)acrylate functional groups unless explicitly stated. For example, a difunctional monomer is understood to mean a monomer with two (meth)acrylate functional groups per molecule. On the other hand, a trifunctional alcohol is understood to mean a compound with three hydroxy groups per molecule with no (meth)acrylate groups. Without further description, “monomer” and “oligomer” are understood to mean (meth)acrylate monomer and (meth)acrylate oligomer, respectively.

The term “monomer” means a compound having a number average molecular weight of less than 1,000 g/mol, in particular 100 to 950 g/mol.

The term “oligomer” means a compound having a number average molecular weight from equal to or more than 1,000, in particular 1,050 to 20,000 g/mol.

The term “mono(meth)acrylate monomer” means a monomer bearing a single (meth)acrylate functional group.

The term “di(meth)acrylate monomer” means a monomer bearing 2 (meth)acrylate functional groups.

The term “urethane (meth)acrylate” refers to a compound comprising a urethane bond and a (meth)acrylate functional group. Such compounds may also be referred to as urethane (meth)acrylate oligomers.

The term “urethane bond” means a —NH—C(═O)—O—or —O—C(═O)—NH— bond.

The term «ester bond» means a —C(═O)—O—or —O—C(═O)— bond.

The term «ether bond» means a —O— bond.

The term «carbonate bond» means a —O—C(═O)—O— bond.

The term «amide bond» means a —C(═O)—NH— or —NH—C(═O)— bond.

The term «urea bond» means a —NH—C(═O)—NH— bond.

The term “diol” means a compound bearing 2 hydroxy groups.

The term «hydroxy group» means a —OH group.

The term “diisocyanate” means a compound bearing 2 isocyanate groups.

The term «isocyanate group» means a —N═C═O group.

The term «amine» means a —NRₐR_{b} group, wherein Rₐ and R_{b} are independently H or a C1-C6 alkyl.

The term “hydroxylated mono(meth)acrylate” means a compound bearing a single (meth)acrylate functional group and one or more hydroxy groups.

The term «oxyalkylene» means a divalent radical of formula —R—O—or —O—R—, wherein R is a dialkylene. Examples of oxyalkylenes include oxyethylene, oxypropylene and oxybutylene.

The term “oxyethylene unit(s)” means —(O—CH₂—CH₂)— unit(s)

The term “oxypropylene unit(s)” means —(O—CH(CH₃)—CH₂)— and/or —(O—CH₂—CH(CH₃))— unit(s).

The term “oxybutylene unit(s)” means —(O—CH₂—CH₂—CH₂—CH₂)—, —(O—CH(CH₃)—CH₂—CH₂)—, —(O—CH₂—CH(CH₃)—CH₂)—, —(O—CH₂—CH₂—CH(CH₃))—, —(O—CH(C₂H₅)—CH₂)—, —(O—CH₂—CH(C₂H₅))— and/or —(O—CH(CH₃)—CH(CH₃))— unit(s). The oxybutylene unit(s) may be derived from 1,2-butanediol, 1,3-butanediol, 2,3-butanediol and/or 1,4-butanediol (which is also referred to as tetramethylene glycol), preferably 1,4-butanediol. In particular, “oxybutylene unit(s)” means —(O—CH₂—CH₂—CH₂—CH₂)— unit(s).

The term «aliphatic compound/group» means an optionally substituted non-aromatic acyclic compound/group. It may be linear or branched, saturated or unsaturated. It may comprise one or more bonds selected from ether, ester, amide, urethane, urea and mixtures thereof.

The term «cycloaliphatic compound/group» means a non-aromatic cyclic compound/group. It may be substituted by one or more groups as defined for the term «aliphatic». It may comprise one or more bonds as defined for the term «aliphatic».

The term «aromatic compound/group» means a compound/group comprising an aromatic ring, which means that respects Hickeys aromaticity rule, in particular a compound/group comprising a phenyl group. It may be substituted by one or more groups as defined for the term «aliphatic». It may comprise one or more bonds as defined for the term «aliphatic».

The term «acyclic compound/group» means a compound/group that does not comprise any rings.

The term «cyclic compound/group» means a compound/group that comprises one or more rings.

The term “dialkylene” means a divalent radical obtained by removing two hydrogen groups from an alkane. A “C2-C8 dialkylene” means a dialkylene having 2 to 8 carbon atoms. Examples of suitable dialkylenes are methylene, ethylene, propylene, isopropylene, butylene, isobutylene, pentylene and hexylene.

The term “alkane” means a saturated acyclic compound of formula CrIT An alkane may be linear or branched.

The term “hydrocarbyl” means a monovalent or divalent radical comprising carbon and hydrogen atoms. A hydrocarbyl may be linear or branched, saturated or unsaturated, cyclic or acyclic. A C2-C100 hydrocarbyl means a hydrocarbyl having 2 to 100 carbon atoms. A hydrocarbyl may optionally be substituted. A hydrocarbyl may optionally be interrupted by one or more heteroatoms selected from O, N, S and Si.

The term «optionally substituted compound/group» means a compound/group substituted by one or more groups selected from alkyl, cycloalkyl, aryl, heteroaryl, alkoxy, alkylaryl, haloalkyl, hydroxy, halogen, isocyanate, nitrile, amine, carboxylic acid, —C(═O)-R′ —C(═O)—OR′, —C(═O)NH—R′, —NH—C(═O)R′, —O—C(═O)—NH—R′, —NH—C(═O)—O—R′, —C(═O)—O—C(═O)—R′ and —SO₂—NH—R′, each R′ being independently an optionally substituted group selected from alkyl, aryl and alkylaryl.

The term «alkyl» means a monovalent saturated acyclic hydrocarbon radical of formula —CₙH₂ₙ₊₁. An alkyl may be linear or branched. A «C 1-C20 alkyl» means an alkyl having 1 to 20 carbon atoms. Examples of alkyl groups include methyl, ethyl, propyl, isopropyl, butyl, isobutyl, tert-butyl, pentyl and hexyl.

The term «hydroxyalkyl» means an alkyl substituted with at least one hydroxy group.

The term «cycloalkyl» means a non-aromatic cyclic hydrocarbon group. A cycloalkyl may comprise one or more carbon-carbon double bonds. A «C3-C8 cycloalkyl» means a cycloalkyl having 3 to 8 carbon atoms. Examples of cycloalkyl groups include cyclopentyl, cyclohexyl and isobornyl.

The term «heterocycloalkyl» means a cycloalkyl having at least one ring atom that is a heteroatom selected from O, N, or S.

The term «aryl» means an aromatic hydrocarbon group. A «C6-C12 aryl» means an aryl having 6 to 12 carbon atoms.

The term «heteroaryl» means an aryl having at least one ring atom that is a heteroatom such as O, N, S and mixtures thereof. A «C5-C9 heteroaryl» means a heteroaryl having 5 to 9 carbon atoms.

The term «alkoxy» means a group of formula -O-Alkyl.

The term «alkylaryl» means an alkyl substituted by an aryl group. A «C7-C20 alkylaryl» means an alkylaryl having 7 to 20 carbon atoms. An example of an alkylaryl group is benzyl (—CH₂-Phenyl).

The term «arylalkyl» means an aryl substituted by an alkyl group.

The term «haloalkyl» means an alkyl substituted by one or more halogen atoms.

The term «halogen» means an atom selected from Cl, Br and I.

The term “ethylenically unsaturated compound” means a compound that comprises a polymerizable carbon-carbon double bond. A polymerizable carbon-carbon double bond is a carbon-carbon double bond that can react with another carbon-carbon double bond in a polymerization reaction. A polymerizable carbon-carbon double bond is generally comprised in a group selected from acrylate (including cyanoacrylate), methacrylate, acrylamide, methacrylamide, styrene, maleate, fumarate, itaconate, allyl, propenyl, vinyl and combinations thereof, preferably selected from acrylate, methacrylate and vinyl, more preferably selected from acrylate and methacrylate. The carbon-carbon double bonds of a phenyl ring are not considered as polymerizable carbon-carbon double bonds.

As used herein, the term “alkoxylated” refers to compounds in which one or more epoxides such as ethylene oxide and/or propylene oxide have been reacted with active hydrogen-containing groups (e.g., hydroxy groups) of a base compound, such as a polyol, to form one or more oxyalkylene moieties. For example, from 1 to 25 moles of epoxide may be reacted per mole of base compound.

Elastic Material

The elastic material of the present invention has a rebound resilience greater than 10%, in particular greater than 15%, more particularly greater than 20%. The elastic material may have a rebound resilience greater than 20%. In particular, the elastic material may have a rebound resilience greater than 22%, greater than 25%, greater than 30% or greater than 35%.

For example, the elastic material may have a rebound resilience from 21 to 60%, from 25 to 55%, from 30 to 50% or from 35 to 45%. In an alternative embodiment, the elastic material may have a rebound resilience of greater than 10% to 20%, for example from 11 to 20%, from 12 to 20%, from 14 to 20%, from 15 to 20%. The rebound resilience may be measured according to JIS K 6255:1996.

In one embodiment, the elastic material may have an elongation greater than 300%, greater than 350%, greater than 400% or greater than 450%. For example, the elastic material may have an elongation from 350 to 1,500%, from 400 to 1,400% or from 450 to 1,300%. The elongation may be measured according to JIS K 7127:1999.

The elastic material, may have a Shore A hardness of at least 15, at least 20, at least 25, at least 30, at least 35, at least 40 or at least 45. The Shore A hardness may, for example, be not more than 100, not more than 90, not more than 80, not more than 70, or not more than 60. For example, the elastic material may have a Shore A hardness of from 15 to 90, from 20 to 80, from 25 to 70, from 30 to 60 or from 35 to 55. The Shore A hardness may be measured according to JIS K 6253-3:2012.

The curable composition used to prepare an elastic material in accordance with the invention may advantageously be a liquid at room temperature (e.g., 25° C.) under normal pressure (e.g., 100 kPa). As used herein, the term “liquid” means that a composition that flows under its own weight. For example, the curable composition may have a viscosity at 60° C. of not more than 20,000 mPa·s, not more than 10,000 mPa·s, not more than 8,000 mPa·s, or not more than 5,000 mPa·s. The viscosity may be measured with a rotational Brookfield viscometer.

Such properties may be adjusted and varied as may be desired by selecting and combining various ingredients of the curable composition used to prepare the elastic material, as described hereinafter in more detail. For example, changing the types and relative amounts of substances employed as components a) and b) of the curable composition can lead to variations in the elongation, rebound resilience and/or Shore A hardness of the elastic material obtained therefrom.

Component a)

The curable composition used to prepare the elastic material according to the invention comprises, as component a), a urethane (meth)acrylate comprising oxybutylene units. Component a) may comprise a mixture of urethane (meth)acrylates comprising oxybutylene units.

The weight content of oxybutylene units in the urethane (meth)acrylate may be at least 45% based on the total weight of urethane (meth)acrylate. In particular, the weight content of oxybutylene units may be from 45 to 95%, from 50% to 95%, from 55% to 95%, from 60% to 95%, from 65% to 95%, from 70% to 95%, from 75% to 95%, from 78% to 95%, from 80% to 95% or from 80% to 90%, based on the total weight of urethane (meth)acrylate. The weight content of oxybutylene units may be determined by calculating the weight of oxybutylene units in the compounds used to prepare the urethane (meth)acrylate with respect to the total weight of the compounds used to prepare the urethane (meth)acrylate.

The urethane (meth)acrylate comprises a urethane bond. In one embodiment, the urethane (meth)acrylate comprises two or more urethane bonds per molecule on average. For example, the urethane (meth)acrylate may comprise from 1,8 to 10, from 1,9 to 5 or from 2 to 3 urethane bonds per molecule on average. In a particularly preferred embodiment the urethane (meth)acrylate may comprise 2 urethane bonds per molecule on average

The urethane (meth)acrylate comprises a (meth)acrylate functional group. In a preferred embodiment, the urethane (meth)acrylate of component a) does not have more than two (meth)acrylate functional groups per molecule on average. In particular, the urethane (meth)acrylate comprises at least one acrylate functional group.

Urethane (meth)acrylates suitable for use as component a) in the curable compositions of the present invention may be functionalized solely with acrylate functional groups, solely with methacrylate functional groups, or with both acrylate and methacrylate functional groups (e.g., it is possible to employ a urethane that contains both acrylate and methacrylate functional groups on the same molecule). For example, it may be advantageous under certain circumstances to employ a urethane (meth)acrylate having a molar ratio of acrylate functional groups: methacrylate functional groups of 1:3 to 3:1, 1:2 to 2:1, or 1:1.5 to 1.5:1.

Typically, the urethane (meth)acrylate may bear (meth)acrylate functional groups at one or more terminal ends of the molecule, but it is also possible for (meth)acrylate functional groups to be positioned along the backbone of the molecule. The average (meth)acrylate functionality of the urethane (meth)acrylate of component a) generally may be up to 2 (i.e., an average of 2 (meth)acrylate functional groups per molecule), but in other embodiments the average (meth)acrylate functionality may be less than 2, not more than 1.9, not more than 1.8, not more than 1.7, not more than 1.6, or not more than 1.5.

The number average molecular weight (Mn) of the urethane (meth)acrylate used as component a) is at least 4,700 g/mol. The Mn of component a) may be measured using gel permeation chromatography and polystyrene calibration standards as described herein. The Mn of component a) may be measured as a whole. Thus, if component a) contains a single urethane (meth)acrylate, then its Mn should be at least 4,700 g/mol. In embodiments of the invention where component a) contains two or more urethane (meth)acrylates, it is possible for one or more of such compounds to have an Mn of less than 4,700 g/mol, provided that at least one other such compound present in component a) has an Mn of at least 4,700 g/mol and the Mn of the multiple urethane (meth)acrylate when combined in the proportions utilized in component a) is at least 4,700 g/mol.

According to various embodiments of the invention, the Mn of component a) may be at least 5,000 g/mol, at least 5,500 g/mol, at least 6,000 g/mol, at least 6,500 g/mol or at least 7,000 g/mol. In particular, the Mn of component a) may not be greater than 50,000 g/mol, not greater than 30,000 g/mol, not greater than 25,000 g/mol, not greater than 20,000 g/mol, not greater than 18,000 g/mol or not greater than 15,000 g/mol. For example, the Mn of component a) may be from 4,700 to 50,000 g/mol, from 5,000 to 30,000 g/mol, from 5,500 to 25,000 g/mol, from 6,000 to 20,000 g/mol, from 6,500 to 18,000 g/mol or from 7,000 to 15,000 g/mol. In a particularly preferred embodiment, the Mn of component a) may be from 5,500 to 20,000 g/mol, from 5,500 to 18,000 or from 5,500 to 15,000 g/mol.

In one embodiment, the urethane (meth)acrylate of component a) may have a relatively low glass transition temperature (Tg) as measured by differential scanning calorimetry. For example, the urethane (meth)acrylate may have a Tg less than 0° C., less than −10° C., less than −20° C., less than −30° C., less than −40° C., less than −50° C., less than −60° C., or less than −70° C.

Particularly preferred urethane (meth)acrylates suitable for use as component a) include compounds having the following general formula (I):

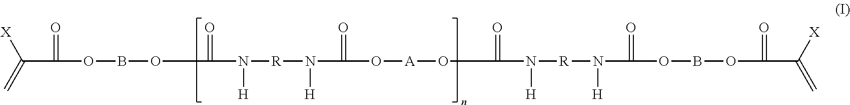

wherein

each A is independently the residue of a diol and at least one A comprises oxybutylene units;

each R is independently the residue of a diisocyanate;

each B is independently the residue of a hydroxylated mono(meth)acrylate;

each X is independently H or methyl;

n is 1 to 9, preferably 1 to 4, more preferably 1 to 2, even more preferably n is 1.

In particular, each A is independently the residue of a diol comprising oxybutylene units.

As used herein, the term “residue of a diol” means the moiety between the two hydroxy groups of a diol. At least one A may be the residue of a diol of formula HO-A-OH wherein A comprises oxybutylene units. In particular, each A is the residue of a diol of formula HO-A-OH wherein A comprises oxybutylene units. If a mixture of diols is used, A may correspond to A₁ or A₂, A₁ being the residue of a diol HO-A₁-OH and A₂ being the residue of a diol HO-A₂-OH with the proviso that at least one of A₁ and A₂ comprises oxybutylene units. A, A₁ and A₂ are preferably free of urethane bonds.

In one embodiment, at least one A, in particular each A, may be the residue of a diol comprising 2 to 200, in particular 10 to 100, more particularly 13 to 50, oxybutylene units. In particular, the diol may have a number average molecular weight of at least 1,100 g/mol, more particularly from 1,200 to 5,000 g/mol, or from 1,400 to 4,000 g/mol.

At least one A, in particular each A, may be the residue of a diol further comprising oxyalkylene repeating units other than oxybutylene units, such as oxyethylene and/or oxypropylene units.

At least one A, in particular each A, may correspond to a poly(oxyalkylene) comprising oxybutylene units and optionally oxyethylene and/or oxypropylene units. For example, at least one A, in particular each A, may correspond to the following formula -(Alk'-O)_{b}-Alk′-

wherein each Alk′ is independently a linear or branched C2-C4 dialkylene, with the proviso that at least part of the -Alk′- units are a C4 dialkylene, in particular at least part of the -Alk'- units are —(CH₂)₄—;

b is 2 to 200, in particular 10 to 100, more particularly 13 to 50.

At least one A, in particular each A, may comprise at least 50%, at least 55%, at least 60%, at least 65%, at least 70%, at least 75%, at least 80%, at least 85%, at least 90%, at least 95%, at least 98%, at least 99%, or 100% by weight of oxybutylene repeating units based on the total weight of oxyalkylene repeating units (i.e. oxybutylene, oxyethylene and oxypropylene repeating units).

In a particularly preferred embodiment, at least one A, in particular each A, may be the residue of a polytetramethylene ether glycol, in particular a polytetramethylene ether glycol having a number average molecular weight of at least 1,100 g/mol, or from 1,200 to 5,000 g/mol, or from 1,400 to 4,000 g/mol. The residue of a polytetramethylene ether glycol may be represented by the following formula —[(CH₂)₄—O]b—(CH₂)₄—

wherein b is 2 to 200, in particular 10 to 100, more particularly 13 to 50.

As used herein, the term “residue of a diisocyanate” means the moiety between the two isocyanate groups of a diisocyanate. Accordingly, R may be the residue of a diisocyanate of formula OCN—R—NCO. In one embodiment, R may be the residue of an aromatic, aliphatic or cycloaliphatic diisocyanate. In particular, R may be the residue of an aliphatic or cycloaliphatic diisocyanate, such as an isocyanate comprising a C4-C12 hydrocarbon chain or one or more cyclohexyl groups. More particularly, R may be the residue of a cycloaliphatic diisocyanate. Even more particularly, R may be the residue of isophorone diisocyanate.

Examples of suitable diisocyanates having an aliphatic residue are 1,4-tetramethylene diisocyanate, 1,5-pentamethylene diisocyanate (PDI), 1,6-hexamethylene diisocyanate (HDI), trimethylhexamethylene diisocyanate (TMDI), 1,12-dodecane diisocyanate.

Examples of suitable diisocyanates having an cycloaliphatic residue are 1,3- and 1,4-cyclohexane diisocyanate, isophorone diisocyanate (IPDI corresponding to 3-isocyanatomethyl-3,5,5-trimethylcyclohexylisocyanate), dicyclohexylmethane-4,4′-diisocyanate (HMDI or hydrogenated MDI), 2,4-diisocyanato-1-methylcyclohexane, 2,6-diisocyanato-1-methylcyclohexane.

Examples of suitable diisocyanates having an aromatic residue are 4,4′-methylene diphenyl diisocyanate (MDI), 2,4- and 2,6-toluene diisocyanate (TDI), 1,4-benzene diisocyanate, 1,5-naphtalene diisocyanate (NDI), m-tetramethylene xylylene diisocyanate, 4,6-xylylene diisocyanate.

As used herein, the term “residue of a hydroxylated mono(meth)acrylate” means the moiety between the (meth)acrylate functional group and a hydroxy group of a hydroxylated mono(meth)acrylate. Accordingly, B may be the residue of a hydroxylated mono(meth)acrylate of formula CH₂═C(X)—(C═O)—O—B—OH where X is H or methyl.

In one embodiment, B may be the residue of a hydroxylated mono(meth)acrylate having a molecular weight of less than 600 g/mol, less than 550 g/mol, less than 500 g/mol, less than 400 g/mol, less than 350 g/mol, less than 300 g/mol, less than 250 g/mol, less than 200 g/mol or less than 150 g/mol.

B may correspond to a C2-C100 hydrocarbyl. The C2-C100 hydrocarbyl may optionally be substituted by one or more hydroxy groups. The C2-C100 hydrocarbyl may optionally be interrupted by one or more oxygen atoms. In particular, the C2-C100 hydrocarbyl may comprise an oxyalkylene unit, in particular at least two oxyalkylene units. The oxyalkylene unit may be selected from oxyethylene, oxypropylene, oxybutylene and mixtures thereof.

B may optionally comprise one or more oxyalkylene units, in particular no more than 3 oxyalkylene units. The oxyalkylene unit may be selected from oxyethylene, oxypropylene, oxybutylene and mixtures thereof, preferably oxyethylene, oxybutylene and mixtures thereof.

In one embodiment, B may be substantially free of oxypropylene units, in particular B may be substantially free of oxyalkylene units.

More particularly, B may correspond to formula -(Alk-O)ₚ-(L)_{q}—(O-Alk)ᵣ- wherein each Alk is independently a linear or branched C2-C4 dialkylene, preferably ethylene or butylene;

L is a C2-C20 hydrocarbyl optionally substituted by one or more hydroxy groups, preferably a C2-C10 dialkylene;

p and r are independently from 0 to 20, preferably from 1 to 15, more preferably from 2 to 10;

q is 0 or 1, preferably 1;

with the proviso that p, q and r are not all 0.

In a preferred embodiment, p and r are independently from 0 to 3. In a particularly preferred embodiment, the sum p +r is from 0 to 3, even more preferably 0.

Examples of such hydroxylated mono(meth)acrylates include 2-hydroxyethyl acrylate, 2-hydroxyethyl methacrylate, 2-hydroxypropyl acrylate, 2-hydroxypropyl methacrylate, 3-hydroxypropyl acrylate, 3-hydroxypropyl methacrylate, 4-hydroxybutyl acrylate, 4-hydroxybutyl methacrylate, 5-hydroxypentyl acrylate, 5-hydroxypentyl methacrylate, 6-hydroxyhexyl acrylate, 6-hydroxyhexyl methacrylate, neopentyl glycol monoacrylate, neopentyl glycol monomethacrylate, trimethylolpropane monoacrylate, trimethylolpropane monomethacrylate, triethylolpropane monoacrylate, triethylolpropane monomethacrylate, pentaerythritol monoacrylate, pentaerythritol monomethacrylate, glycerol monoacrylate, glycerol monomethacrylate, diethylene glycol monoacrylate, diethylene glycol monomethacrylate, triethylene glycol monoacrylate, triethylene glycol monomethacrylate, polyethylene glycol monoacrylate, polyethylene glycol monomethacrylate, dipropylene glycol monoacrylate, dipropylene glycol monomethacrylate, tripropylene glycol monoacrylate, tripropylene glycol monomethacrylate, polypropylene glycol monoacrylate, polypropylene glycol monomethacrylate, dibutylene glycol monoacrylate, dibutylene glycol monomethacrylate, tributylene glycol monoacrylate, tributylene glycol monomethacrylate, polybutylene glycol monoacrylate, polybutylene glycol monomethacrylate, the alkoxylated (i.e. ethoxylated and/or propoxylated) derivatives of the above mentioned compounds and mixtures thereof.

The following compounds are particularly preferred: 2-hydroxyethyl acrylate, 2-hydroxyethyl methacrylate, 2-hydroxypropyl acrylate, 2-hydroxypropyl methacrylate, 3-hydroxypropyl acrylate, 3-hydroxypropyl methacrylate, 4-hydroxybutyl acrylate, 4-hydroxybutyl methacrylate, 5-hydroxypentyl acrylate, 5-hydroxypentyl methacrylate, 6-hydroxyhexyl acrylate, 6-hydroxyhexyl methacrylate, neopentyl glycol monoacrylate, neopentyl glycol monomethacrylate.

In another embodiment, B may be a residue comprising an ester bond, in particular at least two ester bonds. In particular, B may be a residue comprising polymerized units derived from a lactone, in particular from caprolactone.

More particularly, B may correspond to formula —((CH₂)₅—CO₂)ₘ—R₁— wherein R₁ is a C2-C8, preferably a C2-C6, more preferably a C2-C4 dialkylene; and m is from 1 to 10, preferably from 2 to 8, more preferably from 3 to 5.

Hydroxylated mono(meth)acrylates comprising polymerized units derived from a lactone may be prepared by reaction of a lactone (preferably c-Caprolactone) with a hydroxyalkyl mono(meth)acrylate followed by the ring opening polymerization of said lactone.

The urethane (meth)acrylate of component a) may be the reaction product of one or more diols, one or more diisocyanates and one or more hydroxylated mono(meth)acrylates. The oxybutylene units may typically be comprised in the diol. If a mixture of diols is used, oxybutylene units may typically be comprised in at least one diol, in particular in each diol.

The equivalent ratio R of the diol relative to the hydroxylated mono(meth)acrylate may be from 0.5 to 3, in particular from 0.6 to 2.5, more particularly from 0.7 to 2, even more particularly from 0.8 to 1.8, more particularly still from 1 to 1.5.

The equivalent ratio R may be calculated with the following equation:

$$R = \frac{{n}_{OH \_ diol}}{{n}_{OH \_ acrylate}}$$

wherein

n_{OH_diol} is the number of moles of OH groups in the diol;

n_{OH_acrylate} is the number of moles of OH groups in the hydroxylated mono(meth)acrylate.

When a mixture of diols is used, n_{OH_diol} corresponds to the sum of the number of moles of each diol.

The number of moles of OH groups n_{OH} in a hydroxy-containing compound may be calculated with the following equation:

$${n}_{O H} = \frac{m \times f}{M w}$$

wherein

m is the weight of the hydroxy-containing compound in grams;

Mw is the molecular weight of the hydroxy-containing compound in g/mol;

f is the number of hydroxy groups in the hydroxy-containing compound.

In particular, the urethane (meth)acrylate of component a) may be obtained by a process comprising the following steps:

i) reacting a diisocyanate with a hydroxylated mono(meth)acrylate to form an isocyanate-functional adduct; and

ii) reacting the adduct obtained in step i) with a diol comprising oxybutylene units or a mixture of diols wherein at least one of the diols comprises oxybutylene units.

The diisocyanate used in the process may be a diisocyanate of formula OCN—R—NCO wherein R is as described above. The hydroxylated mono(meth)acrylate may be a hydroxylated mono(meth)acrylate of formula CH_{2═}C(X)—(C═O)—O—B—OH where B and X are as described above. The diol may be a diol of formula HO-A-OH as described above.

The curable composition used to prepare the elastic material of the invention comprises 30 to 90%, in particular 40 to 90%, more particularly 50 to 90% by weight, based on the total weight of components a) and b), of urethane (meth)acrylate having a number average molecular weight of at least 4,700 g/mol and comprising oxybutylene units (i.e., component a)). The curable composition used to prepare the elastic material of the invention may comprises 50 to 90% by weight, based on the total weight of components a) and b), of urethane (meth)acrylate having a number average molecular weight of at least 4,700 g/mol and comprising oxybutylene units (i.e., component a)). In certain embodiments, the amount of component a) in the curable composition is at least 55%, at least 60%, at least 65% or at least 70%, by weight based on the total weight of components a) and b). In other embodiments, the amount of component a) in the curable composition is not more than 85%, not more than 80%, or not more than 75%, by weight based on the total weight of components a) and b). For example, in certain embodiments the curable composition may comprise 55 to 85%, 60 to 80%, or 65 to 75%, by weight of component a), based on the total weight of components a) and b). In an alternative embodiment, the curable composition may comprise 30 to 49%, 35 to 49%, or 40 to 49%, by weight of component a), based on the total weight of components a) and b).

Component b)

The curable composition used to prepare an elastic material in accordance with the invention comprises, as component b), a (meth)acrylate monomer having one or two (meth)acrylate functional groups per molecule. Component b) may comprise a mixture of (meth)acrylate monomers having one or two (meth)acrylate functional groups per molecule.

(Meth)acrylate monomers suitable for use as component b) in the curable compositions of the present invention may be functionalized solely with acrylate functional groups, solely with methacrylate functional groups, or with both acrylate and methacrylate functional groups (e.g., it is possible to employ a (meth)acrylate monomer that contains both acrylate and methacrylate functional groups on the same molecule or to employ a mixture comprising an acrylate monomer and a methacrylate monomer).

In accordance with certain embodiments of the invention, at least 50%, at least 60%, at least 70%, at least 80%, at least 90%, or at least 95% of the (meth)acrylate functional groups in component b) are acrylate functional groups (the balance, if any, being methacrylate functional groups). According to one embodiment, all of the functional groups in component b) are acrylate functional groups.

The (meth)acrylate monomer used as component b) may be a selected from a mono(meth)acrylate monomer, a di(meth)acrylate monomer and mixtures thereof.

In one embodiment, component b) comprises a mono(meth)acrylate monomer. Component b) may comprise a mixture of mono(meth)acrylate monomers.

Examples of suitable mono(meth)acrylate monomers include, but are not limited to, mono(meth)acrylate esters of aliphatic alcohols (wherein the aliphatic alcohol may be straight chain, branched or cyclic and may be a monoalcohol or a polyol, provided only one hydroxy group is esterified with (meth)acrylic acid); mono(meth)acrylate esters of aromatic alcohols (such as phenols, including alkylated phenols); mono(meth)acrylate esters of alkylaryl alcohols (such as benzyl alcohol); mono(meth)acrylate esters of oligomeric glycols (such as diethylene glycol, triethylene glycol, dipropylene glycol, tripropylene glycol, dibutylene glycol, tributylene glycol, polyethylene glycol, polypropylene glycol and polybutylene glycol); mono(meth)acrylate esters of monoalkyl ethers of glycols and oligomeric glycols (such as monomethyl or monoethyl ethers of glycols and oligomeric glycols); mono(meth)acrylate esters of alkoxylated (e.g., ethoxylated and/or propoxylated) aliphatic alcohols (wherein the aliphatic alcohol may be straight chain, branched or cyclic and may be a monoalcohol or a polyol, provided only one hydroxy group of the alkoxylated aliphatic alcohol is esterified with (meth)acrylic acid); mono-(meth)acrylate esters of alkoxylated (e.g., ethoxylated and/or propoxylated) aromatic alcohols (such as alkoxylated phenols); caprolactone mono(meth)acrylates; and the like.

Exemplary mono(meth)acrylate monomers include, 2-hydroxyethyl acrylate, 2-hydroxypropyl acrylate, 4-hydroxybutyl acrylate, diethylene glycol monoacrylate, diethylene glycol monomethacrylate, methoxydiethylene glycol monoacrylate, methoxydiethylene glycol monomethacrylate, ethoxydiethylene glycol monoacrylate, ethoxydiethylene glycol monomethacrylate, triethylene glycol monoacrylate, triethylene glycol monomethacrylate, methoxytriethylene glycol monoacrylate, methoxytriethylene glycol monomethacrylate, ethoxytriethylene glycol monoacrylate, ethoxytriethylene glycol monomethacrylate, polyethylene glycol monoacrylate, polyethylene glycol monomethacrylate, methoxypolyethylene glycol monoacrylate, methoxypolyethylene glycol monomethacrylate, ethoxypolyethylene glycol monoacrylate, ethoxypolyethylene glycol monomethacrylate, polypropylene glycol monoacrylate, polypropylene glycol monomethacrylate, 2-ethoxyethyl acrylate, 2-(2-ethoxyethoxy)ethyl acrylate, a polycaprolactone acrylate, tetrahydrofurfuryl acrylate, tetrahydrofurfuryl methacrylate, 2-phenoxyethyl acrylate, phenyl acrylate, (5-ethyl-1,3-dioxan-5-yl)methyl acrylate (or CTFA), (2,2-dimethyl-1,3-dioxolan-4-yl)methyl acrylate (or IPGA), (2,2-dimethyl-1,3-dioxolan-4-yl)methyl methacrylate (or IPGMA) (2-ethyl-2-methyl-1,3-dioxolan-4-yl)methyl acrylate, glycerol formal methacrylate (or Glyfoma), 2-[[(butylamino)carbonyl]oxy]ethyl acrylate, octyl/decyl acrylate, cetyl/stearyl acrylate, cetyl/stearyl methacrylate, iso-octyl acrylate, iso-octyl methacrylate, iso-decyl acrylate, iso-decyl methacrylate, dodecyl acrylate, tridecyl acrylate, tridecyl methacrylate, stearyl acrylate, stearyl methacrylate, behenyl acrylate, behenyl methacrylate, 2-ethylhexyl acrylate, 2-ethylhexyl methacrylate, butyl acrylate, butyl methacrylate, iso-butyl acrylate, heptadecyl acrylate, propylheptyl acrylate, dodecyl methacrylate, benzyl acrylate, cyclohexyl acrylate, 2-carboxyethyl acrylate, 2-hydroxypropyl methacrylate, 2-hydroxyethyl methacrylate, acryloyl morpholine, 2-phenoxyethyl methacrylate, tert-butylcyclohexyl acrylate, tert-butylcyclohexyl methacrylate, trimethylcyclohexyl acrylate, trimethylcyclohexyl methacrylate, isobornyl acrylate, isobornyl methacrylate, dicyclopentadienyl acrylate, dicyclopentadienyl methacrylate, tert-butyl acrylate, tert-butyl methacrylate, cyclohexyl methacrylate, benzyl methacrylate, tricyclodecane methanol monoacrylate, glycidyl acrylate, glycidyl methacrylate, nonylphenol acrylate, allyl acrylate, allyl methacrylate, para-cumyl phenyl ether acrylate, the alkoxylated (i.e. ethoxylated and/or propoxylated) derivatives of the above mentioned compounds and mixtures thereof.

Component b) may comprise a mono(meth)acrylate monomer having a glass transition temperature Tg of more than 20° C. Such a monomer may be referred to as a “hard monomer”. Conversely, a mono(meth)acrylate monomer having a Tg below 20° C. is referred to as a soft monomer. The Tg of a monomer corresponds to the Tg of the corresponding homopolymers as measured by differential scanning calorimetry.

The hard monomer may have a Tg of at least 40° C., at least 50° C., at least 60° C., at least 70° C., or at least 75° C.

Example of suitable hard monomers include tert-butylcyclohexyl acrylate, tert-butylcyclohexyl methacrylate, trimethylcyclohexyl acrylate, trimethylcyclohexyl methacrylate, isobornyl acrylate, isobornyl methacrylate, tert-butyl acrylate, tert-butyl methacrylate, cyclohexyl methacrylate, benzyl methacrylate, tricyclodecane methanol monoacrylate and mixtures thereof.

In particular, the hard monomer may represent at least 10%, from 10 to 100%, from 20 to 100%, from 30 to 100%, from 40 to 100%, from 50 to 100%, from 60 to 100%, from 70 to 100%, from 80 to 100%, from 90 to 100%, or even 100% by weight of the total weight of component b).Component b) may comprise a sterically hindered mono(meth)acrylate monomer. A sterically-hindered mono(meth)acrylate monomer may comprise a cyclic moiety and/or a tert-butyl group. The cyclic moiety may be monocyclic, bicyclic or tricyclic, including bridged, fused and/or spirocyclic ring systems. The cyclic moiety may be carbocyclic (all of the ring atoms are carbons), or heterocyclic (the rings atoms consist of at least two elements). The cyclic moiety may be aliphatic, aromatic or a combination of aliphatic and aromatic. In particular, the cyclic moiety may comprise a ring or ring system selected from cycloalkyl, heterocycloalkyl, aryl, heteroaryl and combinations thereof. More particularly, the cyclic moiety may comprise a ring or ring system selected from phenyl, cyclopentyl, cyclohexyl, norbornyl, tricyclodecanyl, dicyclopentadienyl, oxiranyl, oxetanyl, tetrahydrofuranyl, tetrahydropyranyl, dioxolanyl, dioxanyl, dioxaspirodecanyl and dioxaspiroundecanyl. The ring or ring system may be optionally substituted by one or more groups selected from hydroxyl, alkoxy, alkyl, hydroxyalkyl, cycloalkyl, aryl, alkylaryl and arylalkyl.

In particular, the cyclic moiety may correspond to one of the following formulae:

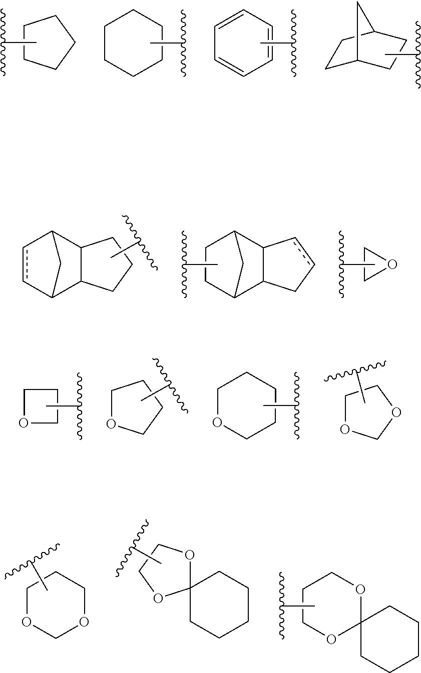

wherein

the symbol [symbol] represent the point of attachment to a moiety comprising a (meth)acrylate group,

the hashed bond [symbol] represent a single bond or a double bond;

and each ring atom may be optionally substituted by one or more groups selected from hydroxyl, alkoxy, alkyl, hydroxyalkyl, cycloalkyl, aryl, alkylaryl and arylalkyl.

In particular, the sterically hindered mono(meth)acrylate monomer comprises a cyclic moiety, such as a moiety comprising an aliphatic ring, in particular an aliphatic ring selected from cyclohexane, tricyclodecane, tetrahydrofuran, bornane. 1,3-dioxolane and 1,3-dioxane.

Examples of sterically hindered mono(meth)acrylate monomers are tert-butyl (meth)acrylate, 2-phenoxyethyl (meth)acrylate, benzyl (meth)acrylate, isobornyl (meth)acrylate, tert-butyl cyclohexyl (meth)acrylate, 3,3,5-trimethyl cyclohexyl (meth)acrylate, dicyclopentadienyl (meth)acrylate, tricyclodecane methanol mono(meth)acrylate, tetrahydrofurfuryl (meth)acrylate, cyclic trimethylolpropane formyl (meth)acrylate (also referred to as 5-ethyl-1,3-dioxan-5-yl)methyl (meth)acrylate), (2,2-dimethyl-1,3-dioxolan-4-yl)methyl (meth)acrylate, (2-ethyl-2-methyl-1,3-dioxolan-4-yl)methyl (meth)acrylate, glycerol formal methacrylate, the alkoxylated derivatives thereof and mixtures thereof.

Specific examples of sterically hindered mono(meth)acrylate monomer are tert-butyl cyclohexyl acrylate, tert-butylcyclohexyl methacrylate, isobornyl acrylate, isobornyl methacrylate, (5-ethyl-1,3-dioxan-5-yl)methyl acrylate (or CTFA), (2,2-dimethyl-1,3-dioxolan-4-yl)methyl acrylate (or IPGA), (2,2-dimethyl-1,3-dioxolan-4-yl)methyl methacrylate (or IPGMA), (2-ethyl-2-methyl-1,3-dioxolan-4-yl)methyl acrylate, glycerol formal methacrylate (or Glyfoma), 3,5,5-trimethyl cyclohexyl acrylate, 3,5,5-trimethyl cyclohexyl methacrylate, tricyclodecane methanol monoacrylate, tricyclodecane methanol monomethacrylate, tetrahydrofurfuryl acrylate and tetrahydrofurfuryl methacrylate.

In a preferred embodiment, component b) comprises a mono(meth)acrylate monomer selected from isobornyl acrylate, tert-butyl cyclohexyl acrylate, (5-ethyl-1,3-dioxan yl)methyl acrylate (or CTFA), tetrahydrofurfuryl acrylate and mixtures thereof.

In particular, the sterically-hindered mono(meth)acrylate monomer may represent at least 10%, from 10 to 100%, from 20 to 100%, from 30 to 100%, from 40 to 100%, from 50 to 100%, from 60 to 100%, from 70 to 100%, from 80 to 100%, from 90 to 100%, or even 100% by weight of the total weight of component b).

In one embodiment, component b) may comprise a mixture of a hard monomer and a soft monomer. The hard monomer may be as defined above. The soft monomer may have a Tg of not more than 10° C., not more than 0° C., not more than −10° C., not more than −20° C., or not more than −25° C. In certain embodiments, the difference in such glass transition temperatures (i.e., the difference between the Tg of the hard monomer and the Tg of the soft monomer) is at least 50° C., at least 60° C., at least 70° C., at least 80° C., at least 90° C. or at least 100° C.

The relative amounts of the hard and soft monomers in the curable composition may be varied as may be desired depending upon, for example, the properties of the urethane (meth)acrylate also present in the curable composition and the properties (e.g., hardness) desired in the elastic material obtained from the curable composition. Generally speaking, however, the mass ratio of hard monomer(s) to soft monomer(s) in the curable composition may suitably be from 1:10 to 10:1, from 1:5 to 5:1, from 1:4 to 4:1, from 1:3 to 3:1, or from 1:2 to 2:1. Generally speaking, the Shore A hardness of the elastic material may be increased by increasing the amount of hard monomer relative to the amount of soft monomer, if all other attributes of the curable composition are held constant.

In one embodiment component b) comprises a di(meth)acrylate monomer. Component b) may comprise a mixture of di(meth)acrylate monomers.

Suitable di(meth)acrylate monomers include (meth)acrylates of diols and alkoxylated diols. (Meth)acrylates of polyols and alkoxylated polyols having more than 2 hydroxy groups per molecule on average can be used, provided that an average of 2 hydroxy groups on the polyol or alkoxylated polyol have been esterified with (meth)acrylic acid.

Examples of suitable di(meth)acrylate monomers include: di(meth)acrylates of ethylene glycol, diethylene glycol, triethylene glycol, and tetraethylene glycol (e.g., tetraethylene glycol di(meth)acrylate); di(meth)acrylates of polyethylene glycols, wherein the polyethylene glycols have a number average molecular weight of 150 to 250 Daltons (e.g., polyethylene glycol di(meth)acrylates); di(meth)acrylates of 1,4-butanediol (e.g., 1,4-butanediol di(meth)acrylates); (meth)acrylates of 1,6-hexane diol (e.g., 1,6-hexane diol di(meth)acrylates); di(meth)acrylates of neopentyl glycol (e.g., neopentyl glycol di(meth)acrylate); di(meth)acrylates of 1,3-butylene glycol (e.g., 1,3-butylene glycol di(meth)acrylates); di(meth)acrylates of ethoxylated bisphenol A containing 1 to 25 oxyethylene units per molecule (e.g., bisphenol A ethoxylated with from 1 to 35 equivalents of ethylene oxide and then (meth)acrylated); and combinations thereof.

Exemplary di(meth)acrylate monomers include, but are not limited to, ethylene glycol diacrylate, ethylene glycol dimethacrylate, diethylene glycol diacrylate, diethylene glycol dimethacrylate, triethylene glycol diacrylate, triethylene glycol dimethacrylate, polyethylene glycol diacrylate, polyethylene glycol dimethacrylate, propylene glycol diacrylate, propylene glycol dimethacrylate, dipropylene glycol diacrylate, dipropylene glycol dimethacrylate, tripropylene glycol diacrylate, triethylene glycol dimethacrylate, polypropylene glycol diacrylate, polypropylene glycol dimethacrylate, 1,4-butanediol diacrylate, 1,4-butanediol dimethacrylate, 1,3-butanediol diacrylate, 1,3-butanediol dimethacrylate, 1,5-pentanediol diacrylate, 1,5-pentanediol dimethacrylate, 1,6-hexanediol diacrylate, 1,6-hexanediol dimethacrylate, 1,10-decanediol diacrylate, 1,10-decanediol dimethacrylate, 1,12-dodecanediol diacrylate, 1,12-dodecanediol dimethacrylate, bisphenol A diacrylate, bisphenol A dimethacrylate, neopentyl glycol diacrylate, neopentyl glycol dimethacrylate, trimethylolpropane diacrylate, trimethylolpropane dimethacrylate, triethylolpropane diacrylate, triethylolpropane dimethacrylate, pentaerythritol diacrylate, pentaerythritol dimethacrylate, glycerol diacrylate, glycerol dimethacrylate, polybutadiene diacrylate, polybutadiene dimethacrylate, 3-methyl-1,5-pentanediol diacrylate, cyclohexane dimethanol diacrylate, cyclohexane dimethanol dimethacrylate, tricyclodecane dimethanol diacrylate, tricyclodecane dimethanol dimethacrylate, metallic diacrylate, modified metallic diacrylate, metallic dimethacrylate, modified metallic dimethacrylate, the alkoxylated (i.e. ethoxylated and/or propoxylated) derivatives of the above mentioned compounds and mixtures thereof.

The curable composition used to prepare the elastic material of the invention comprises 10 to 70%, in particular 10 to 60%, more particularly 10 to 50% by weight, based on the total weight of components a) and b), of (meth)acrylate monomer having one or two (meth)acrylate functional groups per molecule (i.e., component b)). The curable composition used to prepare the elastic material of the invention may comprise 10 to 50% by weight, based on the total weight of components a) and b), of (meth)acrylate monomer having one or two (meth)acrylate functional groups per molecule (i.e., component b)). In certain embodiments, the amount of component b) in the curable composition is at least 12%, at least 15%, at least 20% or at least 30%, by weight based on the total weight of components a) and b). In other embodiments, the amount of component b) in the curable composition is not more than 45% or not more than 40%, by weight based on the total weight of components a) and b). For example, in certain embodiments the curable composition may comprise 15 to 45%, 20 to 40%, or 30 to 40%, by weight of component b), based on the total weight of components a) and b). In an alternative embodiment, the curable composition may comprise 51 to 70%, 51 to 65%, or 51 to 60%, by weight of component b), based on the total weight of components a) and b).

The amount of di(meth)acrylate monomer in component b) may advantageously be kept relatively low so that the component b) is mainly constituted of mono(meth)acrylate monomer. Indeed, if the amount of di(meth)acrylate monomer in component b) is too high, it could reduce the elastic properties of the resulting material due to excessive crosslinking.

In a preferred embodiment, mono(meth)acrylate monomers constitute at least 80%, at least 85%, at least 90%, at least 95%, at least 98%, at least 99% or at least 99.5% by weight or 100% by weight of the total weight of component b).

Curable Component c) Other than Components a) and b)

The curable composition used to prepare an elastic material in accordance with the invention may comprise a curable component c) other than components a) and b). The curable composition may comprise a mixture of curable components c) other than components a) and b).

The curable component c) consists of any ethylenically unsaturated compound present in the composition, other than a urethane (meth)acrylate having a number average molecular weight of at least 4,700 g/mol and comprising oxybutylene units and a (meth)acrylate monomer having one or two (meth)acrylate functional groups per molecule.

The curable component c) may comprise a monomer, an oligomer and mixtures thereof, in particular a (meth)acrylate monomer, a (meth)acrylate oligomer and mixtures thereof.

In one embodiment, the curable component c) comprises a (meth)acrylate oligomer.

Suitable oligomers include, but are not limited to, epoxy (meth)acrylate oligomers, urethane (meth)acrylate oligomers other than component a), polyester (meth)acrylate oligomers, (meth)acrylic (meth)acrylate oligomers, and amino (meth)acrylate oligomers. The oligomer structure may contain segments characteristic of more than one of the oligomer classes listed above. The oligomer may contain both “hard” and “soft” segments and, further, may be a block copolymer. The oligomer may contain regions where the structure is similar to that of common elastomeric materials (e.g., polyurethane, polyisoprene, polybutadiene, polyisobutylene) or may contain no structural similarities to conventional elastomers.

Examples of suitable epoxy (meth)acrylate oligomers include the reaction products of acrylic or methacrylic acid or mixtures thereof with epoxy-group containing compounds such as glycidyl ethers or esters. The epoxy (meth)acrylate oligomers may be hydroxy-functional (i.e., contain one or more hydroxy groups as well as one to two (meth)acrylate functional groups per molecule). Suitable hydroxy-functional epoxy (meth)acrylate oligomers include, but are not limited to, oligomeric compounds obtainable by reaction of an epoxy compound (such as an epoxy resin oligomer or other epoxy-functionalized oligomer) with (meth)acrylic acid wherein ring-opening of the epoxy group by the (meth)acrylic acid introduces both hydroxy and (meth)acrylate functionality. The starting epoxy compound may be a bisphenol epoxy resin, for example. It is also possible to obtain epoxy (meth)acrylate oligomers by functionalizing an oligomer such as a polyoxyalkylene glycol or polybutadiene with one to two epoxy groups and then reacting the epoxy group(s) with (meth)acrylic acid. Examples of suitable hydroxy-functional epoxy (meth)acrylates include aliphatic epoxy (meth)acrylate oligomers having both (meth)acrylate functionality and secondary hydroxy functionality due to ring-opening of an epoxy group.

Urethane (meth)acrylate oligomers capable of being used in the curable compositions of the present invention include urethanes based on aliphatic and/or aromatic polyester polyols and polyether polyols and aliphatic and/or aromatic polyester diisocyanates and polyether diisocyanates capped with one to two (meth)acrylate end-groups. Suitable urethane (meth)acrylate oligomers include, for example, aliphatic polyester-based urethane mono- and di-acrylate oligomers, aliphatic polyether-based urethane mono- and di-acrylate oligomers, as well as aliphatic polyester/polyether-based urethane mono- and di-acrylate oligomers.

In various embodiments, the urethane (meth)acrylate oligomers may be prepared by reacting aliphatic and/or aromatic diisocyanates with OH group terminated polyester polyols (including aromatic, aliphatic and mixed aliphatic/aromatic polyester polyols), polyether polyols (in particular, polypropylene glycols), polycarbonate polyols, polycaprolactone polyols, polydimethysiloxane polyols, or polybutadiene polyols, or combinations thereof to form isocyanate-functionalized oligomers which are then reacted with hydroxy-functionalized (meth)acrylates such as hydroxyalkyl (meth)acrylates (e.g., hydroxyethyl acrylate or hydroxyethyl methacrylate) to provide one to two terminal (meth)acrylate groups.

Particularly preferred urethane acrylate oligomers suitable for use in the present invention include oligomers formed by the reaction of polyol(s), diisocyanate(s), and (meth)acrylic acid or hydroxyalkyl (meth)acrylates.

Exemplary polyester (meth)acrylate oligomers include the reaction products of acrylic or methacrylic acid or mixtures thereof with hydroxy group-terminated polyester polyols. The reaction process may be conducted such that all or only a portion of the hydroxy groups of the polyester polyol have been (meth)acrylated. The polyester polyols can be made by polycondensation reactions of polyhydroxy functional components (in particular, diols such as glycols and oligoglycols) and polycarboxylic acid functional compounds (in particular, dicarboxylic acids and anhydrides). The polyhydroxy functional and polycarboxylic acid functional components can each have linear, branched, cycloaliphatic or aromatic structures and can be used individually or as mixtures.

Suitable (meth)acrylic (meth)acrylate oligomers (sometimes also referred to in the art as “acrylic oligomers” or “(meth)acrylic oligomers”) include oligomers which may be described as substances having an oligomeric acrylic backbone which is functionalized with one or two (meth)acrylate groups (which may be at a terminus of the oligomer or pendant to the acrylic backbone). The (meth)acrylic backbone may be a homopolymer, random copolymer or block copolymer comprised of repeating units of (meth)acrylic monomers. The (meth)acrylic monomers may be any monomeric (meth)acrylate such as C1-C6 alkyl (meth)acrylates as well as functionalized (meth)acrylates such as (meth)acrylates bearing hydroxyl, carboxylic acid and/or epoxy groups. (Meth)acrylic (meth)acrylate oligomers may be prepared using any procedures known in the art, such as by oligomerizing monomers, at least a portion of which are functionalized with hydroxyl, carboxylic acid and/or epoxy groups (e.g., hydroxyalkyl(meth)acrylates, (meth)acrylic acid, glycidyl (meth)acrylate) to obtain a functionalized oligomer intermediate, which is then reacted with one or more (meth)acrylate-containing reactants to introduce the desired (meth)acrylate functional groups.

Suitable (meth)acrylate oligomers also include amine-modified derivatives of the afore-mentioned (meth)acrylate oligomers. Such products are obtained by reacting part of the (meth)acrylate functional groups of the (meth)acrylate oligomers with a secondary amine in a Michael addition.

The curable component c) may comprise a (meth)acrylate monomer comprising more than 2 (meth)acrylate functional groups per molecule, typically comprising three or more (meth)acrylate functional groups per molecule.

(Meth)acrylate monomers comprising three or more (meth)acrylate functional groups per molecule may be (meth)acrylate esters of polyols (polyhydric alcohols) or alkoxylated polyols containing three or more hydroxy groups per molecule, provided that at least three of the hydroxy groups are (meth)acrylated.

Specific examples of suitable polyols include glycerin, trimethylolpropane, ditrimethylolpropane, pentaerythritol, dipentaerythritol, sugar alcohols, the alkoxylated (i.e. ethoxylated and/or propoxylated) derivatives of the above mentioned compounds and mixtures thereof. Such polyols may be fully or partially esterified (with (meth)acrylic acid, (meth)acrylic anhydride, (meth)acryloyl chloride or the like), provided the product obtained therefrom contains at least three (meth)acrylate functional groups per molecule.

Exemplary (meth)acrylate monomers containing three or more (meth)acrylate functional groups per molecule may include trimethylolpropane triacrylate, trimethylolpropane trimethacrylate, tris (2-hydroxyethyl) isocyanurate triacrylate, tris (2-hydroxyethyl) isocyanurate trimethacrylate, pentaerythritol triacrylate, pentaerythritol trimethacrylate, glyceryl triacrylate, di-trimethylolpropane triacrylate, di-trimethylolpropane trimethacrylate, di-trimethylolpropane tetraacrylate, di-trimethylolpropane tetramethacrylate, pentaerythritol triacrylate, pentaerythritol trimethacrylate, pentaerythritol tetraacrylate, pentaerythritol tetramethacrylate, dipentaerythritol pentaacrylate, dipentaerythritol pentamethacrylate, the alkoxylated (i.e. ethoxylated and/or propoxylated) derivatives of the above mentioned compounds and mixtures thereof.

The amount of curable component c) may be kept relatively low so that the curable composition is mainly constituted of components a) and b).

In a preferred embodiment, components a) and b) constitute at least 90%, at least 95%, or at least 99% by weight or 100% by weight of the total amount of curable components (i.e. components a), b) and c)) present in the curable composition.

Initiator System Component d)

The curable composition used to prepare an elastic material in accordance with the present invention may also optionally comprise an initiator system (also referred to as component d)). The initiator system includes one or more substances capable of initiating curing (polymerization) of components a), b) and c) (independently or in cooperation with other substances), typically in response to external stimuli such as heat or light. For example, the curable composition may comprise one or more photoinitiator(s) for the purpose of initiating the polymerization of the (meth)acrylate-functionalized components of the curable composition upon exposure to light. Photoinitiator(s) will advantageously be included whenever the curable composition is intended to be polymerized by ultraviolet (UV) or visible actinic radiation (i.e, cured by UV bulb or an LED). Curable compositions intended to be polymerized by electron beam (EB) will usually not comprise a photoinitiator. An exemplary curable composition may contain, for example, 0-20%, 0-15%, 0-10% or 0-5% by weight of photoinitiator, based on the total weight of the curable composition. The curable composition may comprise, for example, at least 0.01%, at least 0.05%, at least 0.1%, or at least 0.5% by weight of photoinitiator, based on the total weight of the curable composition.

In one embodiment, the curable composition may comprise from 0.01 to 10%, or from 0.05 to 5% or from 0.1 to 2%, by weight of photoinitiator, based on the total weight of the curable composition. Preferred photoinitiators are those that are capable of absorbing frequencies of light emitted by the desired energy source, as is ordinary knowledge in the industry.

A photoinitiator may be considered any type of substance that, upon exposure to radiation (e.g., actinic radiation), forms species that initiate the reaction and curing of polymerizing organic substances present in the curable composition. Suitable photoinitiators include free radical photoinitiators. The photoinitiator should be selected so that it is susceptible to activation by photons of the wavelength associated with the actinic radiation (e.g., ultraviolet radiation, visible light) intended to be used to cure the photocurable composition.

Free radical photoinitiators can adopt two different modes of action, and are classified by mode of action as Norrish Type I and Norrish Type II Photoinitiators. Norrish Type I photoinitiators cleave upon exposure to radiation, producing radical species which are capable of initiating the polymerisation of unsaturated compounds. Norrish Type II photoinitiators are compounds which do not fragment upon exposure to radiation and so will not typically initiate radical-chain polymerisation unless a co-initiator is present. Upon exposure to radiation, interaction between the Type II photoinitiator and the co-initiator leads to the generation of radical species which can initiate the polymerisation of UV-curable resins. Some radical photoinitiators may comprise two different photoactive moieties and exhibit both Norrish Type I and Norrish Type II activity. In this case, one moiety may be cleaved in two radical fragments and the other may be transformed into a radical by abstraction of an atom on exposure to radiation.

Non-limiting types of free radical photoinitiators suitable for use in the curable compositions employed in the present invention include, for example, benzoins, benzoin ethers, acetophenones, a-hydroxy acetophenones, benzyl, benzyl ketals, anthraquinones, phosphine oxides, acylphosphine oxides, a-hydroxyketones, phenylglyoxylates, a-aminoketones, benzophenones, thioxanthones, xanthones, acridine derivatives, phenazene derivatives, quinoxaline derivatives, triazine compounds, benzoyl formates, aromatic oximes, metallocenes, acylsilyl or acylgermanyl compounds, camphorquinones, polymeric derivatives thereof, and mixtures thereof.

Examples of particular suitable free radical photoinitiators include, but are not limited to, 2-methylanthraquinone, 2-ethylanthraquinone, 2-chloroanthraquinone, 2-benzylanthraquinone, 2-t-butylanthraquinone, 1,2-benzo-9,10-anthraquinone, benzyl, benzoins, benzoin ethers, benzoin, benzoin methyl ether, benzoin ethyl ether, benzoin isopropyl ether, alpha-methylbenzoin, alpha-phenylbenzoin, Michler's ketone, acetophenones such as 2,2-dialkoxybenzophenones and 1-hydroxyphenyl ketones, benzophenone, 4,4′-bis-(diethylamino) benzophenone, acetophenone, 2,2-diethyloxyacetophenone, diethyloxyacetophenone, 2-isopropylthioxanthone, thioxanthone, diethyl thioxanthone, 1,5-acetonaphthylene, ethyl-p-dimethylaminobenzoate, benzil ketone, a-hydroxy keto, 2,4,6-trimethylbenzoyldiphenyl phosphine oxide, benzyl dimethyl ketal, 2,2-dimethoxy-1,2-diphenylethanone, 1-hydroxycylclohexyl phenyl ketone, 2-methyl-1[4-(methylthio) phenyl]-2-morpholinopropanone-1, 2-hydroxy-2-methyl-1-phenyl-propanone, oligomeric a-hydroxy ketone, benzoyl phosphine oxides, phenylbis(2,4,6-trimethylbenzoyl)phosphine oxide, ethyl-4-dimethylamino benzoate, ethyl(2,4,6-trimethylbenzoyl)phenyl phosphinate, anisoin, anthraquinone, anthraquinone-2-sulfonic acid, sodium salt monohydrate, (benzene) tricarbonylchromium, benzil, benzoin isobutyl ether, benzophenone/l-hydroxycyclohexyl phenyl ketone, 50/50 blend, 3,3′,4,4′-benzophenonetetracarboxylic dianhydride, 4-benzoylbiphenyl, 2-benzyl-2-(dimethylamino)-4′-morpholinobutyrophenone, 4,4′-bis(diethylamino)benzophenone, 4,4′-bis(dimethylamino)benzophenone, camphorquinone, 2-chlorothioxanthen-9-one, dibenzosuberenone, 4,4′-dihydroxybenzophenone, 2,2-dimethoxy-2-phenylacetophenone, 4-(dimethylamino)benzophenone, 4,4′-dimethylbenzil, 2,5-dimethylbenzophenone, 3,4-dimethylbenzophenone, diphenyl(2,4,6-trimethylbenzoyl)phosphine oxide/2-hydroxy-2-methylpropiophenone, 50/50 blend, 4′-ethoxyacetophenone, 2,4,6-trimethylbenzoyldiphenylphophine oxide, phenyl bis(2,4,6-trimethyl benzoyl)phosphine oxide, ferrocene, 3′-hydroxyacetophenone, 4′-hydroxyacetophenone, 3-hydroxybenzophenone, 4-hydroxybenzophenone, 1-hydroxycyclohexyl phenyl ketone, 2-hydroxy-2-methylpropiophenone, 2-methylbenzophenone, 3-methylbenzophenone, methybenzoylformate, 2-methyl-4′-(methylthio)-2-morpholinopropiophenone, phenanthrenequinone, 4′-phenoxyacetophenone, (cumene)cyclopentadienyl iron(ii) hexafluorophosphate, 9,10-diethoxy and 9,10-dibutoxyanthracene, 2-ethyl-9,10-dimethoxyanthracene, thioxanthen-9-one and combinations thereof.

Additives—Component e)

The curable composition used to prepare an elastic material in accordance with the present invention may also optionally comprise an additive (also referred to as component e)). The curable composition may comprise a mixture of additives.

In particular, the additive may be selected from adhesion enhancers, sensitizers, amine synergists, antioxidants/photostabilizers, light blockers/absorbers, polymerization inhibitors, foam inhibitors, flow or leveling agents, colorants, pigments, dispersants (wetting agents, surfactants), slip additives, fillers, chain transfer agents, thixotropic agents, matting agents, impact modifiers, waxes, mixtures thereof, and any other additives conventionally used in the coating, sealant, adhesive, molding, 3D printing or ink arts.

In one embodiment, the composition may comprise an additive that improves adhesion, but is not (meth)acrylate-functionalized (i.e., contain no (meth)acrylate functionality). This additive may improve the adhesion of the elastic material obtained from the curable composition to a substrate (in particular a surface of a substrate). Additives that enhance adhesion but do not contain reactive (meth)acrylate functional groups include tackifying resins, polymers that have intrinsic adhesive properties such as tack, or components that do not have intrinsic adhesive properties but enhance adhesiveness when included as a component of the curable composition. An adhesion-enhancing additive that does not contain (meth)acrylate functionality may be used at 0-30% (w/w) loading, for example.

The curable composition may comprise a sensitizer and/or an amine synergist. Sensitizers may be introduced in the curable composition of the present invention in order to extend the sensitivity of the photoinitiator to longer wavelengths. For example, the sensitizer may absorb light at longer or shorter wavelengths than the photoinitiator and be capable of transferring the energy to the photoinitiator and revert to its ground state. Examples of suitable sensitizers include benzophenones, anthracenes, thioxanthones (2-isopropylthioxanthone, 2,4-diethylthioxanthone, 1-chloro-4-propoxythioxanthone), xanthones, anthrones, anthraquinones (2-ethyl anthraquinone), dibenzosuberone and carbazoles. The concentration of sensitizer in the curable composition will vary depending on the photoinitiator that is used. Typically, however, the curable composition is formulated to comprise from 0% to 5%, in particular 0.1% to 3%, more particularly 0.5 to 2%, by weight of sensitizer based on the total weight of the curable composition.

Amine synergists may be introduced in the curable composition of the present invention in order to act synergistically with Norrish Type II photoinitiators and/or to reduce oxygen inhibition. Amine synergists are typically tertiary amines. When used in conjunction with Norrish Type II photoinitiators, the tertiary amine provides an active hydrogen donor site for the excited triple state of the photoinitiator, thus producing a reactive alkyl-amino radical which can subsequently initiate polymerization. Tertiary amines are also able to convert unreactive peroxy species, formed by reaction between oxygen and free radicals, to reactive alkyl-amino radicals, thus reducing the effects of oxygen on curing. When the composition comprises a cationically polymerizable compound, amine synergists may not be present. Examples of suitable amine synergists include low-molecular weight tertiary amines (i.e. having a molecular weight of less than 200 g/mol) such as triethanol amine, N-methyldiethanol amine. Other types of amine synergists are aminobenzoates or amine-modified acrylates (acrylated amines formed by Michael addition of secondary amines on part of the acrylate groups carried by acrylate functionalized monomers and/or oligomers). Examples of aminobenzoates include ethyl-4-(N,N′-dimethylamino) benzoate (EDB), 2-n-butoxyethyl 4-(dimethylamino) benzoate (BEDB). Examples of commercially available amine-modified acrylate oligomers include CN3705, CN3715, CN3755, CN381 and CN386, all available from Arkema. Polymeric or multi-amino versions are also suitable. The concentration of amine synergist in the curable composition will vary depending on the type of compound that is used. Typically, however, the curable composition is formulated to comprise from 0% to 25%, in particular 0.1% to 10%, more particularly 0.5 to 5%, by weight of amine synergist based on the total weight of the curable composition.

The curable composition may comprise a stabilizer. Stabilizers may be introduced in the curable composition of the present invention in order to provide adequate storage stability and shelf life. The term “stabilizers” includes aerobic inhibitors and/or antioxidants. Advantageously, one or more such stabilizers are present at each stage of the method used to prepare the curable composition, to protect against unwanted reactions during processing of the ethylenically unsaturated components of the curable composition, for example during production of the composition, during storage of the composition at elevated temperature or over extended periods of time, during coating, during other times where the composition is exposed to temperatures above room temperature, or any times when the product is exposed to incidental radiation (such as sunlight) prior to curing. As used herein, the term “stabilizer” means a compound or substance which retards or prevents reaction or curing of actinically-curable functional groups present in a composition in the absence of actinic radiation.

However, it will be advantageous to select an amount and type of stabilizer such that the composition remains capable of being cured when exposed to actinic radiation (that is, the stabilizer does not prevent radiation curing of the composition). Typically, effective stabilizers for purposes of the present invention will be classified as free radical stabilizers (i.e., stabilizers which function by inhibiting free radical reactions). Any of the stabilizers known in the art related to (meth)acrylate-functionalized compounds may be utilized in the present invention. Quinones represent a particularly preferred type of stabilizer which can be employed in the context of the present invention. As used herein, the term “quinone” includes both quinones and hydroquinones as well as ethers thereof such as monoalkyl, monoaryl, monoaralkyl and bis(hydroxyalkyl) ethers of hydroquinones. Hydroquinone monomethyl ether is an example of a suitable stabilizer which can be utilized. Other stabilizers known in the art such as BHT and derivatives, phosphite compounds, phenothiazine (PTZ), triphenyl antimony and tin(II) salts can also be used. The concentration of stabilizer in the curable composition will vary depending upon the particular stabilizer or combination of stabilizers selected for use and also on the degree of stabilization desired and the susceptibility of components in the curable compositions towards degradation in the absence of stabilizer. Typically, however, the curable composition is formulated to comprise from 5 to 5000 ppm stabilizer.

The curable composition may optionally comprise a non-(meth)acrylate component for the purpose of improving performance, managing cost, improving processability, or to otherwise modify the properties and attributes of the curable composition and the elastic material prepared therefrom, such as a filler, a processing aid or an enhancer. Exemplary fillers, processing aids and enhancers may include, but are not limited to, linear low density polyethylene, ultra low density polyethylene, low density polyethylene, high density polyethylene, any other polyethylene, polypropylene, polyvinyl acetate, ethyl vinyl acetate, polyvinyl butyrate, rubbers, thermoplastic urethanes, EVA grafted terpolymer, dry-fumed silica, precipitated silica, surface-modified silica, clay, zeolite, mineral powders, block copolymers, other impact modifiers, engineered polymers such as core-shell particles, organic nanoparticles, and/or inorganic nanoparticles. A curable composition employed in the present invention may, for example, contain 0% to 30% by weight, based on the total weight of the curable composition, of one or more of these additives or fillers.

Pigments may be included as part of the curable composition. A pigment can be any chemical which provides visible color to the finished elastic material. These chemicals include conjugated organic molecules, inorganics, or organometallic compounds. Dyes can also have photochromic, electrochromic, or mechanochromic properties, and can exhibit photoswitching or other responsive visual effects.

The curable composition may comprise a light blocker (sometimes referred to as a light absorber). The introduction of a light blocker is particularly advantageous when the curable composition is to be used as a resin in a three-dimensional printing process involving photocuring of the curable composition. The light blocker may be any such substances known in the three-dimensional printing art, including for example non-reactive pigments and dyes. The light blocker may be a visible light blocker or a UV light blocker, for example. Examples of suitable light blockers include, but are not limited to, titanium dioxide, carbon black and organic ultraviolet light absorbers such as hydroxybenzophenone, hydroxyphenylbenzotriazole, oxanilide, hydroxyphenyltriazine, Sudan I, bromothymol blue, 2,2′-(2,5-thiophenediyl)bis(5-tert-butylbenzoxazole) (sold under the brand name “Benetex OB Plus”) and benzotriazole ultraviolet light absorbers. The amount of light blocker may be varied as may be desired or appropriate for particular applications. Generally speaking, if the curable composition contains a light blocker, it is present in a concentration of from 0.001 to 10% by weight based on the weight of the curable composition.

Advantageously, the curable composition of the present invention may be formulated to be solvent-free, i.e., free of any non-reactive volatile substances (substances having a boiling point at atmospheric pressure of 150° C. or less). For example, the curable composition of the present invention may contain little or no non-reactive solvent, e.g., less than 10% or less than 5% or less than 1% or even 0% non-reactive solvent, based on the total weight of the curable composition. As used herein, the term non-reactive solvent means a solvent that does not react when exposed to the actinic radiation used to cure the curable compositions described herein.

Composition

Exemplary embodiments of the present invention include elastic materials which are the polymerization reaction products of the following curable compositions:

A curable composition comprising components a), b) and c):
component a): 60-70% of urethane (meth)acrylate having a number average molecular weight of at least 4,700 g/mol and comprising oxybutylene units;
component b): 30-40% of mono (meth)acrylate, in particular a sterically hindered mono(meth)acrylate monomer, more particularly isobornyl acrylate;
component c): 0.3-5% of photoinitiator;
the % being % by weight based on the total weight of components a), b) and c).

A curable composition comprising components a), b) and c):
component a): 60-70% of urethane (meth)acrylate which is the reaction product of a polytetramethylene glycol having a number molecular weight of at least 1,100 g/mol, one or more diisocyanates and one or more hydroxylated mono(meth)acrylates;
component b): 30-40% of mono (meth)acrylate, in particular a sterically hindered mono(meth)acrylate monomer, more particularly isobornyl acrylate;
component c): 0.3-5% of photoinitiator;
the % being % by weight based on the total weight of components a), b) and c).

According to various embodiments of the invention, the curable composition may be characterized as comprising less than 10%, less than 5%, less than 1%, less than 0.5%, less than 0.1%, or less than 0.01% by weight or even 0% by weight, based on the total weight of the curable composition, of one or more of the following ingredients:
an elongation promoter which is a sulfur-containing compound, in particular a sulfur-containing compound having a molecular weight of less than 1,000 Daltons, as described in U.S. Pat. Nos. 6,265,476 and 7,198,576;
an oligomer or monomer, exclusive of (meth)acrylate functional groups, having an ethylenically unsaturated functional group (i.e., a functional group which contains ethylenic unsaturation which is other than a (meth)acrylate functional group, such as a vinyl group), as described in US Pat. Nos. 6,265,476 and 7,198,576;
a polythiol compound having 2 to 6 mercapto groups per molecule, as described in US Pat. Pub No. 2012/0157564 A1;
a polysiloxane selected from acryloxyalkyl and methacryloxyalkyl-terminated polydialkylsiloxanes, i.e., a (meth)acrylated polysiloxane as described in U.S. Pat. No. 5,268,396;
a rubber (elastomer) that does not contain (meth)acrylate functional groups;
a rubber containing (meth)acrylate functional groups that has elastomeric properties in its uncured state; and/or
silica.

Preparation of the Curable Composition

Typically, it will be desirable for the various components of the curable composition to be combined and mixed together until homogenous. The production process can be tailored based on the identities and amounts of different ingredients used in the curable composition, processability considerations, or anything else deemed important to production. For example, the ingredients can be added in any order, individually or as premixed blends with other ingredient(s) in the curable composition, slowly or quickly, and at any temperature. To combine and homogenize the components of the curable composition, elevated temperatures and/or agitation may be required. Typically, the processing temperature is advantageously maintained below temperatures that would cause premature polymerization of components of the curable composition.

In particular, the curable composition may be obtained by preparing a urethane (meth)acrylate according to component a) as defined above. The (meth)acrylate monomer according to component b) as defined above may be added during and/or after the preparation of the urethane (meth)acrylate.

Applying/Using the Curable Composition

According to aspects of the invention, the curable composition may be applied to a substrate, in particular to one or more surfaces of a substrate. Any means of coating, depositing, or applying liquid curable compositions known in the art may be used here. These methods include, but are not limited to, coating, rolling, extruding, injecting, spraying, and others. In some cases, the curable composition is heated above room temperature before being applied to the substrate. In other cases, the curable composition is applied at ambient temperature (e.g., room temperature or about 15° C. to about 30° C.). The substrate may optionally be pretreated to improve its adhesion to the elastic material obtained by polymerizing the curable composition. The curable composition may be applied with the intention of permanently bonding the elastic material obtained therefrom with the substrate. Alternatively, the substrate may be a nonstick material (e.g., a release liner film) such that the substrate can be easily removed or separated from the elastic material after curing. The curable composition may be applied or deposited onto a previously cured layer of a curable composition in accordance with the present invention. An article comprised of elastic material in accordance with the present invention may be formed by any suitable method such as casting or 3D printing.

Curing of the Curable Composition

In accordance with aspects of the present invention, the above-described composition may be polymerized into a solid, dimensionally stable material with elastomeric properties. The components of the curable composition may be selected such that the curable composition is capable of polymerizing upon exposure to UV or visible radiation from any light source or by EB. In one embodiment, a layer of the curable composition is passed under an energy source on a conveyor line, web, etc. The curing may happen in a manufacturing setting or may occur at remote locations, for example in the field, home, or as part of a “do it yourself ” application. The curing of a layer of the curable composition may happen while that layer is in contact with a previously cured layer. The curing may occur as part of a 3D printing process.

The method for making the elastic material according to the invention comprises curing the curable composition of the invention. In particular, the curable composition may be cured by exposing the composition to radiation. More particularly, the curable composition may be cured by exposing the composition to an electron beam (EB), a light source (for example a visible light source, a near-UV light source, an ultraviolet lamp (UV), a light-emitting diode (LED) or an infrared light source) and/or heat.

Curing may be accelerated or facilitated by supplying energy to the curable composition, such as by heating the curable composition. Thus, the elastic material may be deemed as the reaction product of the curable composition, formed by curing. A curable composition may be partially cured by exposure to actinic radiation, with further curing being achieved by heating the partially cured elastic material. For example, a product formed from the curable composition may be heated at a temperature of from 40° C. to 120° C. for a period of time of from 5 minutes to 12 hours.

Prior to curing, the curable composition may be applied to a substrate surface in any known conventional manner, for example, by spraying, jetting, knife coating, roller coating, casting, drum coating, dipping, and the like and combinations thereof. Indirect application using a transfer process may also be used.

The substrate on which the curable composition is applied and cured may be any kind of substrate. Curable compositions in accordance with the present invention may also be formed or cured in a bulk manner (e.g., the curable composition may be cast into a suitable mold and then cured).

The elastic material obtained with the process of the invention may be a coating, an adhesive, a sealant, a molded article, or a 3D-printed article, in particular a coating or a 3D-printed article.

A 3D-printed article may, in particular, be obtained with a process for the preparation of a 3D-printed article that comprises printing a 3D article with the curable composition of the invention. In particular, the process may comprise printing a 3D article layer by layer or continuously.

A plurality of layers of a curable composition in accordance with the present invention may be applied to a substrate surface; the plurality of layers may be simultaneously cured (by exposure to a single dose of radiation, for example) or each layer may be successively cured before application of an additional layer of the curable composition.

The curable compositions which are described herein can be used as resins in three-dimensional printing applications. Three-dimensional (3D) printing (also referred to as additive manufacturing) is a process in which a 3D digital model is manufactured by the accretion of construction material. The 3D printed object is created by utilizing the computer-aided design (CAD) data of an object through sequential construction of two dimensional (2D) layers or slices that correspond to cross-sections of 3D objects. Stereolithography (SL) is one type of additive manufacturing where a liquid resin is hardened by selective exposure to a radiation to form each 2D layer. The radiation can be in the form of electromagnetic waves or an electron beam. The most commonly applied energy source is ultraviolet, near-UV, visible or infrared radiation.

Sterolithography and other photocurable 3D printing methods typically apply low intensity light sources to radiate each layer of a photocurable resin to form the desired article. As a result, photocurable resin polymerization kinetics and the green strength of the printed article are important criteria if a particular photocurable resin will sufficiently polymerize (cure) when irradiated and have sufficient green strength to retain its integrity through the 3D printing process and post-processing.

The curable compositions of the invention may be used as 3D printing resin formulations, that is, compositions intended for use in manufacturing three-dimensional articles using 3D printing techniques. Such three-dimensional articles may be free-standing/self-supporting and may consist essentially of or consist of a composition in accordance with the present invention that has been cured. The three-dimensional article may also be a composite, comprising at least one component consisting essentially of or consisting of a cured composition as previously mentioned as well as at least one additional component comprised of one or more materials other than such a cured composition (for example, a metal component or a thermoplastic component or inorganic filler or fibrous reinforcement). The curable compositions of the present invention are particularly useful in digital light printing (DLP), although other types of three-dimensional (3D) printing methods may also be practiced using the inventive curable compositions (e.g., SLA, inkjet, multi-jet printing, piezoelectric printing, actinically-cured extrusion, and gel deposition printing). The curable compositions of the present invention may be used in a three-dimensional printing operation together with another material which functions as a scaffold or support for the article formed from the curable composition of the present invention.

Thus, the curable compositions of the present invention are useful in the practice of various types of three-dimensional fabrication or printing techniques, including methods in which construction of a three-dimensional object is performed in a step-wise or layer-by-layer manner. In such methods, layer formation may be performed by solidification (curing) of the curable composition under the action of exposure to radiation, such as visible, UV or other actinic irradiation. For example, new layers may be formed at the top surface of the growing object or at the bottom surface of the growing object. The curable compositions of the present invention may also be advantageously employed in methods for the production of three-dimensional objects by additive manufacturing wherein the method is carried out continuously. For example, the object may be produced from a liquid interface. Suitable methods of this type are sometimes referred to in the art as “continuous liquid interface (or interphase) product (or printing)” (“CLIP”) methods. Such methods are described, for example, in WO 2014/126830; WO 2014/126834; WO 2014/126837; and Tumbleston et al., “Continuous Liquid Interface Production of 3D Objects,” Science Vol. 347, Issue 6228, pp. 1349-1352 (Mar. 20, 2015.

The curable composition may be supplied by ejecting it from a printhead rather than supplying it from a vat. This type of process is commonly referred to as inkjet or multijet 3D printing. One or more UV curing sources mounted just behind the inkjet printhead cures the curable composition immediately after it is applied to the build surface substrate or to previously applied layers. Two or more printheads can be used in the process which allows application of different compositions to different areas of each layer. For example, compositions of different colors or different physical properties can be simultaneously applied to create 3D printed parts of varying composition. In a common usage, support materials — which are later removed during post-processing — are deposited at the same time as the compositions used to create the desired 3D printed part. The printheads can operate at temperatures from about 25° C. up to about 100° C. Viscosities of the curable compositions are less than 30 mPa·s at the operating temperature of the printhead.

The process for the preparation of a 3D-printed article may comprise the steps of:

a) providing (e.g., coating) a first layer of a curable composition in accordance with the present invention onto a surface;

b) curing the first layer, at least partially, to provide a cured first layer;

c) providing (e.g., coating) a second layer of the curable composition onto the cured first layer;

d) curing the second layer, at least partially, to provide a cured second layer adhered to the cured first layer; and

e) repeating steps c) and d) a desired number of times to build up the three-dimensional article.

After the 3D article has been printed, it may be subjected to one or more post-processing steps. The post-processing steps can be selected from one or more of the following steps removal of any printed support structures, washing with water and/or organic solvents to remove residual resins, and post-curing using thermal treatment and/or actinic radiation either simultaneously or sequentially. The post-processing steps may be used to transform the freshly printed article into a finished, functional article ready to be used in its intended application.

Articles Comprising the Elastic Material

The elastic material of the present invention may be permanently attached to a substrate. Alternatively, the elastic material may provide a free-standing article if removed from the substrate after curing. The elastic material may be in the form of a very thin article (e.g., <1 mil thickness) or a thick article (e.g., >1″ thick). The article comprising the elastic material might be a layered item, produced by alternatively curing a layer of the curable composition and reapplying and curing one or more additional layers of curable composition. Such multi-layered articles encompass articles with a small number of layers (e.g., 2 or 3 layers) as well as those with many layers (e.g., >3 layers, such as in certain types of 3D printing).

Within this specification, embodiments have been described in a way which enables a clear and concise specification to be written, but it is intended and will be appreciated that embodiments may be variously combined or separated without departing from the invention. For example, it will be appreciated that all preferred features described herein are applicable to all aspects of the invention described herein.

In some embodiments, the invention herein can be construed as excluding any element or process step that does not materially affect the basic and novel characteristics of the curable compositions, materials, products and articles prepared therefrom and methods for making and using such curable compositions described herein. Additionally, in some embodiments, the invention can be construed as excluding any element or process step not specified herein.

Although the invention is illustrated and described herein with reference to specific embodiments, the invention is not intended to be limited to the details shown. Rather, various modifications may be made in the details within the scope and range of equivalents of the claims and without departing from the invention.

### EXAMPLES

Materials and Methods

The following compounds were used in the examples:

TABLE 1

| | | Chemical name | Mn |
|---|---|---|---|
| Reference | Type | (Supplier) | (g/mol) |
| PTMG1 | Diol | polytetramethylene glycol | 650 |
| | | (Mitsubishi Chemical Corporation) | |
| PTMG2 | | polytetramethylene glycol | 1,000 |
| | | (Mitsubishi Chemical Corporation) | |
| PTMG3 | | polytetramethylene glycol | 1,400 |
| | | (Hodogaya chemical Co,. Ltd) | |
| PTMG4 | | polytetramethylene glycol | 2,000 |
| | | (Mitsubishi Chemical Corporation) | |
| PTMG5 | | polytetramethylene glycol | 3,000 |
| | | (Mitsubishi Chemical Corporation) | |
| PTMG6 | | polytetramethylene glycol | 4,000 |
| | | (Mitsubishi Chemical Corporation) | |
| PPG | | polypropylene glycol | 3,000 |
| | | (Wako pure chemical Industries, Ltd) | |
| PBD | | hydrogenated polybutadiene | 3,000 |
| | | (Cray Valley) | |
| IPDI | Diisocyanate | isophorone diisocyanate | 650 |
| | | (Wako pure chemical Industries, Ltd) | |
| HEA | Hydroxylated | 2-hydroxyethyl acrylate | 116 |
| | mono(meth)acrylate | (Wako pure chemical Industries, Ltd) | |
| IBOA | (Meth)acrylate | isobornyl acrylate | 208 |
| | monomer | (Sartomer (Guangzhou) Chemicals Ltd.) | |
| CTFA | (Meth)acrylate | (5-ethyl-1,3-dioxan-5-yl)methyl acrylate | 200 |
| | monomer | (Sartomer (Guangzhou) Chemicals Ltd.) | |
| TBCHA | (Meth)acrylate | tert-butylcyclohexyl acrylate | 210 |
| | monomer | (Sartomer (Guangzhou) Chemicals Ltd.) | |
| Irgacure 184 | Initiator | 1-hydroxy-cyclohexyl-phenyl-ketone | 204 |
| | | (Tokyo Chemical Industry Co., Ltd) | |

The following methods were used in the application:

Curing Method

The resin was blended with 5% by weight of Irgacure 184 based on the weight of the resin. The blend was coated on a 100 μm PET film with #10 to #50 application wire rod. The coated substrate was cured on a UV curing unit equipped with a 400 to 1000 mJ/cm² Hg lamp at a speed of 15 m/min.

Tensile Testing (Elongation)

Elongation at break (machine direction) was measured on a cured sample (dumbbell No-5) with a thickness of 30 to 100 μm according to JIS K 7127:1999. The distance between the grips was 8 cm. The initial sample length used for the calculation of elongation at break was the length of the narrow part of the specimen (2.5 cm). The strain rate was 2 cm/min.

Rebound Speed

The rebound speed was measured by stretching the cured sample (dumbbell No-5) to double size and then measuring the rebound time manually. The thickness of the cured film was 30-50 μm. Rebound speed has been categorized based on the speed and time of the rebound. The rebound speed orders are 5>4>>3>>>>>>2>>>1

1: No recovery

2: Almost no recovery

3: Slow, more than 1.0 s

4: Fast, less than 1.0 s

5: Very fast, less than 0.5 s

Shore A Hardness

Shore A hardness was measured on a 3 mm thick cured sample with a Shore A hardness tester according to JIS K 6253-3:2012.

Rebound Resilience

Rebound resilience was measured by JIS K 6255: 1996 method, “Physical testing methods for molded products of thermosetting polyurethane elastomers”. The measurement was done on a cylindrical cured sample having a diameter of 30 mm and a height of 12.5 mm. The pendulum test method was used for this measurement. Each sample was tested three times at 25° C.

Number Average Molecular Weight

The number average molecular weight was determined by gel permeation chromatography (GPC) using polystyrene standards. The measurement conditions of GPC are given below.
Model: Hitachi High-Technologies Corporation made by high-performance liquid chromatogram Lachrom Elite
Column: SHODEX GPC KF-G/-401HQ/-402.5HQ/-403HQ (4.6 x 250 mm)
Eluent: THF
Flow rate: 0.45 mL/min
Temperature:40° C.
Injection volume and concentration of sample.:5 μL, 10 mg/mL
Detection: RI (differential refractometer)
System to gather and process data: Hitachi EZChrome Elite

Viscosity

The viscosity was measured at 60° C. using a rotational Brookfield viscometer. As is known in the art, various ASTM methods (such as ASTM D1084 and ASTM D2556), all of which are quite similar, may be used to measure viscosity using a rotational Brookfield viscometer, with the spindle size being selected to make the torque between 50 and 70%. The particular ASTM method will be selected based upon how viscous the liquid sample is and whether the liquid is Newtonian or non-Newtonian in character, among possibly other factors.

Weight Content of Oxybutylene Units

The weight content of oxybutylene units in the urethane (meth)acrylate may be determined by calculating the weight of oxybutylene units in the compounds used to prepare the urethane (meth)acrylate (in grams) with respect to the total weight of the compounds used to prepare the urethane (meth)acrylate (in grams). For example, if the urethane (meth)acrylate is obtained by reacting a diol, a diisocyanate and a hydroxylated mono(meth)acrylate and the oxybutylene units are present only in the diol, the weight content of oxybutylene units (%

OB) may be determined with the following equation:

$$\% OB = \frac{{OB}_{diol}}{{m}_{diol} + {m}_{diisocyanate} + {m}_{a c r y l a t e}} \times 100$$

wherein

OB_{diol} i is the weight of oxybutylene units in the diol;

m_{diol} is the weight of the diol;

m_{diisocyanate} is the weight of the diisocyanate;

m_{acrylate} is the weight of the hydroxylated mono(meth)acrylate.

When the diol is a polytetramethylene glycol, OB_{diol} corresponds to m_{diol}. If a mixture of diols is used, OB_{diol} is the weight of oxybutylene units in the mixture of diols and m_{diol} is the weight of the mixture of diols.

### Example 1: Preparation of a Curable Composition (Comparative)

19.4 grams of IPDI, 15.0 grams of IBOA, 0.1 gram of butylated hydroxytoluene and 0.1 gram of dibutyltin dilaurate were charged into a 1000 mL reactor. 8.15 grams of HEA were added dropwise with dry air sparge and reacted for 2 hours at 50 to 60° C. The mixture was then heated to 75° C. and 37.25 grams of PTMG1 were added in the mixture. After the addition of PTMG1 was completed, 20.0 grams of IBOA were added in the mixture. The final resin was a clear colorless material with a viscosity of 500 mPa·s at 60° C. The final resin comprises 65% by weight of urethane acrylate and 35% by weight of IBOA. The urethane acrylate has a Mn of 2,700 g/mol and a weight content of oxybutylene units of 57%.

### Example 2: Preparation of a Curable Composition (Comparative)

15.7 grams of IPDI, 15.0 grams of IBOA, 0.1 gram of butylated hydroxytoluene and 0.1 gram of dibutyltin dilaurate were charged into a 1000 mL reactor. 6.6 grams of HEA were added dropwise with dry air sparge and reacted for 2 hours at 50 to 60° C. The mixture was then heated to 75° C. and 42.5 grams of PTMG2 were added in the mixture. After the addition of PTMG2 was completed, 20.0 grams of IBOA were added in the mixture. The final resin was a clear colorless material with a viscosity of 600 mPa·s at 60° C. The final resin comprises 65% by weight of urethane acrylate and 35% by weight of IBOA. The urethane acrylate has a Mn of 4,500 g/mol and a weight content of oxybutylene units of 66%.

### Example 3: Preparation of a Curable Composition According to the Invention

12.4 grams of IPDI, 15.0 grams of IBOA, 0.1 gram of butylated hydroxytoluene and 0.1 gram of dibutyltin dilaurate were charged into a 1000 mL reactor. 5.2 grams of HEA were added dropwise with dry air sparge and reacted for 2 hours at 50 to 60° C. The mixture was then heated to 75° C. and 47.2 grams of PTMG3 were added in the mixture. After the addition of PTMG3 was completed, 20.0 grams of IBOA were added in the mixture. The final resin was a clear colorless material with viscosity of 750 mPa·s at 60° C. The final resin comprises 65% by weight of urethane acrylate and 35% by weight of IBOA. The urethane acrylate has a Mn of 5,800 g/mol and a weight content of oxybutylene units of 73%.

### Example 4: Preparation of a Curable Composition According to the Invention

9.5 grams of IPDI, 15.0 grams of IBOA, 0.1 gram of butylated hydroxytoluene and 0.1 gram of dibutyltin dilaurate were charged into a 1000 mL reactor. 4.0 grams of HEA were added dropwise with dry air sparge and reacted for 2 hours at 50 to 60° C. The mixture was then heated to 75° C. and 51.3 grams of PTMG4 were added in the mixture. After the addition of PTMG4 was completed, 20.0 grams of IBOA were added in the mixture. The final resin was a clear colorless material with a viscosity of 1,500 mPa·s at 60° C. The final resin comprises 65% by weight of urethane acrylate and 35% by weight of IBOA. The urethane acrylate has a Mn of 7,900 g/mol and a weight content of oxybutylene units of 79%.

### Example 5: Preparation of a Curable Composition According to the Invention

7.0 grams of IPDI, 15.0 grams of IBOA, 0.1 gram of butylated hydroxytoluene and 0.1 gram of dibutyltin dilaurate were charged into a 1000 mL reactor. 2.95 grams of HEA were added dropwise with dry air sparge and reacted for 2 hours at 50 to 60° C. The mixture was then heated to 75° C. and 54.85 grams of PTMG5 were added in the mixture. After the addition of PTMG5 was completed, 20.0 grams of IBOA were added in the mixture. The final resin was a clear colorless material with a viscosity of 3,000 mPa·s at 60° C. The final resin comprises 65% by weight of urethane acrylate and 35% by weight of IBOA. The urethane acrylate has a Mn of 9,000 g/mol and a weight content of oxybutylene units of 85%.

### Example 6: Preparation of a Curable Composition According to the Invention

7.0 grams of IPDI, 15.0 grams of CTFA, 0.1 gram of butylated hydroxytoluene and 0.1 gram of dibutyltin dilaurate were charged into a 1000 mL reactor. 2.95 grams of HEA were added dropwise with dry air sparge and reacted for 2 hours at 50 to 60° C. The mixture was then heated to 75° C. and 54.85 grams of PTMG5 were added in the mixture. After the addition of PTMG5 was completed, 20.0 grams of CTFA were added in the mixture. The final resin was a clear colorless material with a viscosity of 2,000 mPa·s at 60° C. The final resin comprises 65% by weight of urethane acrylate and 35% by weight of CTFA. The urethane acrylate has a Mn of 8,100 g/mol and a weight content of oxybutylene units of 85%.

### Example 7: Preparation of a Curable Composition According to the Invention

7.0 grams of IPDI, 15.0 grams of TBCHA, 0.1 gram of butylated hydroxytoluene and 0.1 gram of dibutyltin dilaurate were charged into a 1000 mL reactor. 2.95 grams of HEA were added dropwise with dry air sparge and reacted for 2 hours at 50 to 60° C. The mixture was then heated to 75° C. and 54.85 grams of PTMG5 were added in the mixture. After the addition of PTMG5 was completed, 20.0 grams of TBCHA were added in the mixture. The final resin was a clear colorless material with a viscosity of 2,520 mPa·s at 60° C. The final resin comprises 65% by weight of urethane acrylate and 35% by weight of TBCHA. The urethane acrylate has a Mn of 8,500 g/mol and a weight content of oxybutylene units of 85%.

### Example 8: Preparation of a Curable Composition According to the Invention

5.4 grams of IPDI, 15.0 grams of IBOA, 0.1 gram of butylated hydroxytoluene and 0.1 gram of dibutyltin dilaurate were charged into a 1000 mL reactor. 2.3 grams HEA were added dropwise with dry air sparge and reacted for 2 hours at 50 to 60° C. The mixture was then heated to 75° C. and 57.1 grams of PTMG6 were added in the mixture. After the addition of PTMG6 was completed, 20.0 grams of IBOA were added in the mixture. The final resin was a clear colorless material with a viscosity of 4,300 mPa·s at 60° C. The final resin comprises 65% by weight of urethane acrylate and 35% by weight of IBOA. The urethane acrylate has a Mn of 14,200 g/mol and a weight content of oxybutylene units of 88%.

### Example 9: Preparation of a Curable Composition (Comparative)

6.8 grams of IPDI, 15.0 grams of IBOA, 0.1 gram of butylated hydroxytoluene and 0.1 gram of dibutyltin dilaurate were charged into a 1000 mL reactor. 2.85 grams of HEA were added dropwise with dry air sparge and reacted for 2 hours at 50 to 60° C. The mixture was then heated to 75° C. and 55.15 grams of PPG were added in the mixture. After the addition of PPG was completed, 20.0 grams of IBOA were added in the mixture. The final resin was a clear colorless material with a viscosity of 220 mPa·s at 60° C. The final resin comprises 65% by weight of urethane acrylate and 35% by weight of IBOA. The urethane acrylate has a Mn of 8,600 g/mol and a weight content of oxybutylene units of 0%.

### Example 10: Preparation of a Curable Composition (Comparative)

6.5 grams of IPDI, 15.0 grams of IBOA, 0.1 gram of butylated hydroxytoluene and 0.1 gram of dibutyltin dilaurate were charged into a 1000 mL reactor. 2.72 grams of HEA were added dropwise with dry air sparge and reacted for 2 hours at 50 to 60° C. The mixture then heated to 75° C. and 55.58 grams of PBD were added in the mixture. After the addition of PBD was completed, 20.0 grams of IBOA were added in the mixture. The final resin was a clear colorless material with a viscosity of 2,000 mPa·s at 60° C. The final resin comprises 65% by weight of urethane acrylate and 35% by weight of IBOA. The urethane acrylate has a Mn of 8,900 g/mol and a weight content of oxybutylene units of 0%.

### Example 11: Preparation of a Curable Composition According to the Invention

6.3 grams of IPDI, 15.0 grams of IBOA, 0.1 gram of butylated hydroxytoluene and 0.1 gram of dibutyltin dilaurate were charged into a 1000 mL reactor. 2.23 grams of HEA were added dropwise with dry air sparge and reacted for 2 hours at 50 to 60° C. The mixture was then heated to 75° C. and 56.27 grams of PTMG5 were added in the mixture. After the addition of PTMG5 was completed, 20.0 grams of IBOA were added in the mixture. The final resin was a clear colorless material with a viscosity of 3,850 mPa·s at 60° C. The final resin comprises 65% by weight of urethane acrylate and 35% by weight of IBOA. The urethane acrylate has a Mn of 10,600 g/mol and a weight content of oxybutylene units of 82%.

### Example 12: Preparation of a Curable Composition According to the Invention

7.78 grams of IPDI, 15.0 grams of IBOA, 0.1 gram of butylated hydroxytoluene and 0.1 gram of dibutyltin dilaurate were charged into a 1000 mL reactor. 4.08 grams of HEA were added dropwise with dry air sparge and reacted for 2 hours at 50 to 60° C. The mixture was then heated to 75° C. and 52.94 grams of PTMG5 were added in the mixture. After the addition of PTMG5 was completed, 20.0 grams of IBOA were added in the mixture. The final resin was a clear colorless material with a viscosity of 1,850 mPa·s at 60° C. The final resin comprises 65% by weight of urethane acrylate and 35% by weight of IBOA. The urethane acrylate has a Mn of 7,600 g/mol and a weight content of oxybutylene units of 77%.

### Example 13: Preparation of a Curable Composition According to the Invention

9.20 grams of IPDI, 15.0 grams of IBOA, 0.1 gram of butylated hydroxytoluene and 0.1 gram of dibutyltin dilaurate were charged into a 1000 mL reactor. 5.8 grams of HEA were added dropwise with dry air sparge and reacted for 2 hours at 50 to 60° C. The mixture was then heated to 75° C. and 49.8 grams of PTMG5 were added in the mixture. After the addition of PTMG5 was completed, 20.0 grams of IBOA were added in the mixture. The final resin was a clear colorless material with a viscosity of 1,000 mPa·s at 60° C. The final resin comprises 65% by weight of urethane acrylate and 35% by weight of IBOA. The urethane acrylate has a Mn of 6,700 g/mol and a weight content of oxybutylene units of 72%.

### Example 14: Preparation of a Curable Composition According to the Invention

10.7 grams of IPDI, 15.0 grams of IBOA, 0.1 gram of butylated hydroxytoluene and 0.1 gram of dibutyltin dilaurate were charged into a 1000 mL reactor. 7.5 grams of HEA were added dropwise with dry air sparge and reacted for 2 hours at 50 to 60° C. The mixture was then heated to 75° C. and 46.6 grams of PTMG5 were added in the mixture. After the addition of PTMG5 was completed, 20.0 grams of IBOA were added in the mixture. The final resin was a clear colorless material with a viscosity of 700 mPa·s at 60° C. The final resin comprises 65% by weight of urethane acrylate having a Mn of 5,300 g/mol and 35% by weight of IBOA. The urethane acrylate has a Mn of 5,300 g/mol and a weight content of oxybutylene units of 57%.

### Example 15: Properties of the Cured Materials

The resins obtained in Examples 1 to 10 were cured according to the Curing method. The rebound resilience, rebound speed, elongation and Shore A hardness were measured on the cured material according to the methods described herein.

TABLE 2

| | Rebound | | | |
|---|---|---|---|---|
| | resilience | Rebound | Elongation | Shore A |
| | (%) | speed | (%) | Hardness |
| Ex. 1 (comp) | 9 | 1 | 378 | 75 |
| Ex. 2 (comp) | 13 | 2 | 417 | 61 |
| Ex. 3 | 29 | 4 | 470 | 55 |
| Ex. 4 | 39 | 4 | 556 | 47 |
| Ex. 5 | 43 | 5 | 738 | 45 |
| Ex. 6 | 24 | 4 | 637 | 45 |
| Ex. 7 | 22 | 4 | 512 | 40 |
| Ex. 8 | 43 | 4 | 1,297 | 38 |
| Ex. 9 (comp) | 14 | 3 | 530 | 33 |
| Ex. 10 (comp) | 16 | 2 | 685 | 41 |
| Ex. 11 | 28 | 4 | n.d. | n.d. |
| Ex. 12 | 33 | 4 | n.d. | n.d. |
| Ex. 13 | 20 | 3 | n.d. | n.d. |
| Ex. 14 | 16 | 2 | n.d. | n.d. |

The resins of the invention led to cured materials with excellent elongation, medium hardness and having a higher rebound resilience and rebound speed than that obtained with the comparative resins.

1. An elastic material, wherein the elastic material has a rebound resilience greater than 10% as measured according to JIS K 6255:1996 and wherein the elastic material is an energy-cured reaction product of a curable composition comprising components a) and b):
a) 30 to 90% by weight, based on the total weight of components a) and b) of at least one urethane (meth)acrylate having a number average molecular weight of at least 4,700 g/mol and comprising oxybutylene units;
b) 10 to 70% by weight, based on the total weight of components a) and b), of at least one (meth)acrylate monomer having one or two (meth)acrylate functional groups per molecule.

2. The elastic material of claim 1, wherein the weight content of oxybutylene units in the urethane (meth)acrylate is at least 45% based on the total weight of urethane (meth)acrylate.

3. The elastic material of claim 1, wherein component a) comprises a urethane (meth)acrylate having two or more urethane bonds per molecule on average.

4. The elastic material of claim 1, wherein component a) comprises a urethane (meth)acrylate having at least one acrylate functional group.

5. The elastic material of claim 1, wherein component a) comprises a urethane (meth)acrylate having no more than two (meth)acrylate functional groups per molecule on average.

6. The elastic material of claim 1, wherein component a) comprises a urethane (meth)acrylate having a number average molecular weight from 4,700 to 50,000 g/mol.

7. The elastic material of claim 1, wherein component a) comprises a urethane (meth)acrylate having a number average molecular weight from 5,500 to 20,000 g/mol.

8. The elastic material of claim 1, wherein component a) comprises a urethane (meth)acrylate having the following formula (I): 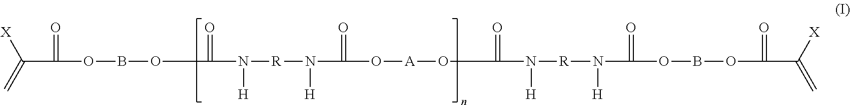
wherein
each A is independently the residue of a diol and at least one A comprises oxybutylene units;
each R is independently the residue of a diisocyanate;
each B is independently the residue of a hydroxylated mono(meth)acrylate;
each X is independently H or methyl;
n is 1 to 9.

9. The elastic material of claim 1, wherein component a) comprises a urethane (meth)acrylate which is the reaction product of one or more diols, one or more diisocyanates and one or more hydroxylated mono(meth)acrylates, wherein at least one diol comprises oxybutylene repeating units.

10. The elastic material of claim 8, wherein the diol is a polytetramethylene ether glycol.

11. The elastic material of claim 8, wherein the diol has a number average molecular weight of at least 1,100 g/mol.

12. The elastic material of claim 8, wherein the diisocyanate is an aliphatic or cycloaliphatic diisocyanate.

13. The elastic material of claim 1, wherein component b) comprises a mono(meth)acrylate monomer having a glass transition temperature Tg of more than 20° C., and the mono(meth)acrylate monomer is selected from the group consisting of tert-butylcyclohexyl acrylate, tert-butylcyclohexyl methacrylate, trimethylcyclohexyl acrylate, trimethylcyclohexyl methacrylate, isobornyl acrylate, isobornyl methacrylate, tert-butyl acrylate, tert-butyl methacrylate, cyclohexyl methacrylate, benzyl methacrylate, tricyclodecane methanol monoacrylate and mixtures thereof.

14. The elastic material of claim 1, wherein component b) comprises a sterically hindered mono(meth)acrylate monomer.

15. The elastic material of claim 14 wherein the sterically hindered mono(meth)acrylate monomer is selected from tert-butyl (meth)acrylate, 2-phenoxyethyl (meth)acrylate, benzyl (meth)acrylate, isobornyl (meth)acrylate, tert-butyl cyclohexyl (meth)acrylate, 3,3,5-trimethyl cyclohexyl (meth)acrylate, dicyclopentadienyl (meth)acrylate, tricyclodecane methanol mono(meth)acrylate, tetrahydrofurfuryl (meth)acrylate, cyclic trimethylolpropane formyl (meth)acrylate (also referred to as 5-ethyl-1,3-dioxan-5-yl)methyl (meth)acrylate), (2,2-dimethyl-1,3-dioxolan-4-yl)methyl (meth)acrylate, (2-ethyl-2-methyl-1,3-dioxolan-4-yl)methyl (meth)acrylate, glycerol formal methacrylate, the alkoxylated derivatives thereof and mixtures thereof.

16. The elastic material of claim 1, wherein component b) comprises at least 80% by weight of mono(meth)acrylate monomer based on the total weight of component b).

17. The elastic material of claim 1, wherein component b) comprises at least 10% by weight of mono(meth)acrylate monomer having a glass transition temperature Tg of more than 20° C., based on the total weight of component b).

18. The elastic material of claim 14, wherein component b) comprises at least 10% by weight of the sterically-hindered mono(meth)acrylate monomer based on the total weight of component b).

19. (canceled)

20. The elastic material of claim 1, wherein the curable composition further comprises an initiator system.

21. (canceled)

22. The elastic material of claim 1, wherein the curable composition is liquid at 25° C.

23. (canceled)

24. The elastic material of claim 1, wherein the elastic material has an elongation greater than 300% as measured according to JIS K 7127:1999.

25. The elastic material of claim 1, wherein the elastic material has a rebound resilience greater than 22% as measured according to JIS K 6255:1996.

26. The elastic material of claim 1, wherein the elastic material has a Shore A hardness of at least 15 as measured according to JIS K 6253-3:2012.

27. A method of making an elastic material having a rebound resilience greater than 10% as measured according to JIS K 6255:1996, comprising curing a curable composition comprising components a) and b):
a) 30 to 90% by weight, based on the total weight of components a) and b), of at least one urethane (meth)acrylate having a number average molecular weight of at least 4,700 g/mol and comprising oxybutylene units;
b) 10 to 70% by weight, based on the total weight of components a) and b), of at least one (meth)acrylate monomer having one or two (meth)acrylate functional groups per molecule.

28. (canceled)
